(19) United States
(12) Patent Application Publication
(10) Pub. No.: US 2026/0212256 A1
(43) Pub. Date: Jul. 23, 2026

(54) GENERATION OF SYNTHETIC DATASETS USING MACHINE LEARNING MODELS FOR ZERO-SHOT CLASSIFICATION

(71) Applicant: International Business Machines Corporation, Armonk, NY (US)

(72) Inventors: Swanand Ravindra Kadhe, San Jose, CA (US); Dinesh C. Verma, New Castle, NY (US); David James Beymer, San Jose, CA (US); PAWAN RAGHUNATH CHOWDHARY, San Jose, CA (US)

(21) Appl. No.: 19/034,806

(22) Filed: Jan. 23, 2025

(51) Int. Cl. G06N 20/00

(52) U.S. Cl. CPC G06N 20/00

(57) ABSTRACT

Generation of synthetic dataset using machine learning (ML) models for zero-shot classification is provided and includes receiving a first input that includes a plurality of labels. A first prompt associated with a first label of the plurality of labels is generated. A first ML model is applied to the first prompt and a first set of labelled datapoints is generated. At least a first sub-prompt associated with at least one labelled datapoint of the first set of labelled datapoints is generated. The first ML model is applied to the at least first sub-prompt and a first subset of labelled datapoints is generated. Based on the first set of labelled datapoints and the first subset of labelled datapoints a training dataset is generated and outputted.

### BACKGROUND

The disclosure relates to generation of synthetic datasets for zero-shot classification.

Zero-shot classification is a machine learning technique in which a machine learning model is designed to classify data without requiring any labelled training data for those specific categories. Zero-shot classification found applications across various domains, including computer vision, natural language processing (NLP), and multimodal tasks. The versatility and efficiency of zero-shot classification make it a promising solution for many real-world applications, driving ongoing research and development in this field. Specifically, zero-shot classification has become increasingly valuable in scenarios where obtaining training data is challenging. This approach is particularly useful in fields like risk assessment on medical data and classification involving proprietary data, where access to extensive labelled datasets is often restricted due to privacy concerns or data scarcity. The ability of zero-shot classification to generalize from limited data and adapt to new, unseen scenarios continues to expand its potential uses across various industries.

### SUMMARY

In various embodiments of the disclosure, a computer-implemented method for the generation of synthetic datasets using machine learning (ML) models for zero-shot classification is described. The computer-implemented method includes receiving, by a computer, a first input including a plurality of labels. The computer-implemented method further includes generating, by the computer, a first prompt associated with a first label of the plurality of labels. The computer-implemented method further includes applying, by the computer, a first ML model to the first prompt. The first ML model is a trained model. The computer-implemented method further includes generating, by the computer, a first set of labelled datapoints based on the application of the first ML model to the first prompt. The computer-implemented method further includes generating, by the computer, at least a first sub-prompt associated with at least one labelled datapoint of the first set of labelled datapoints. The first sub-prompt is different from the first prompt. The computer-implemented method further includes applying, by the computer, the first ML model to the at least first sub-prompt. The computer-implemented method further includes generating, by the computer, a first subset of labelled datapoints based on the application of the first ML model to the at least first sub-prompt. The first subset of labelled datapoints is different from the first set of labelled datapoints. The computer-implemented method further includes generating, by the computer, a training dataset based on the first set of labelled datapoints and the first subset of labelled datapoints. The computer-implemented method further includes outputting, by the computer, the generated training dataset.

In various embodiments of the disclosure, a computer system for the generation of synthetic datasets using machine learning (ML) models for zero-shot classification is described. The computer system includes a processor set, one or more computer-readable storage media, and program instructions stored on the one or more computer-readable storage media. The program instructions are executable by the processor set and cause the processor set to receive a first input that includes a plurality of labels. The program instructions further cause the processor set to generate a first prompt associated with a first label of the plurality of labels. The program instructions further cause the processor set to apply a first machine learning (ML) model to the first prompt. The first ML model is a trained model. The program instructions further cause the processor set to generate a first set of labelled datapoints based on the application of the first ML model to the first prompt. The program instructions further cause the processor set to generate at least a first sub-prompt associated with at least one labelled datapoint of the first set of labelled datapoints. The first sub-prompt is different from the first prompt. The program instructions further cause the processor set to apply the first ML model to the at least first sub-prompt. The program instructions further cause the processor set to generate a first subset of labelled datapoints based on the application of the first ML model to the at least first sub-prompt. The first subset of labelled datapoints is different from the first set of labelled datapoints. The program instructions further cause the processor set to generate a training dataset based on the first set of labelled datapoints and the first subset of labelled datapoints. The program instructions further cause the processor set to train a second ML model based on the training dataset. The second ML model is trained to classify a second input into at least one label of the plurality of labels. The program instructions further cause the processor set to output the second ML model.

In various embodiments of the disclosure, a computer-program product for the generation of synthetic datasets using machine learning (ML) models for zero-shot classification is described. The computer program product includes one or more computer-readable storage media and program instructions stored in the one or more computer-readable storage media to perform operations that include receiving a first input that includes a plurality of labels. The operations further include generating a first prompt associated with a first label of the plurality of labels. The operations further include applying a first ML model to the first prompt. The first ML model is a trained model. The operations further include generating a first set of labelled datapoints based on the application of the first ML model to the first prompt. The operations further include generating at least a first sub-prompt associated with at least one labelled datapoint of the first set of labelled datapoints. The first sub-prompt is different from the first prompt. The operations further include applying the first ML model to the at least first sub-prompt. The operations further include generating a first subset of labelled datapoints based on the application of the first ML model to the at least first sub-prompt. The first subset of labelled datapoints is different from the first set of labelled datapoints. The operations further include generating a training dataset based on the first set of labelled datapoints and the first subset of labelled datapoints. The operations further include outputting the generated training dataset.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures, wherein:

FIG. 1 is a diagram that illustrates a computing environment for generation of synthetic datasets using machine learning (ML) models for zero-shot classification, in accordance with an embodiment of the disclosure;

FIG. 2 is a diagram that illustrates an environment for generation of synthetic datasets using machine learning (ML) models for zero-shot classification, in accordance with an embodiment of the disclosure;

FIG. 3 is a diagram that illustrates exemplary operations for generation of synthetic datasets using machine learning (ML) models for zero-shot classification, in accordance with an embodiment of the disclosure;

FIG. 4 is a diagram that illustrates exemplary operations for application of one or more data processing techniques for generation of synthetic datasets using machine learning (ML) models for zero-shot classification, in accordance with an embodiment of the disclosure;

FIG. 5 is a diagram that illustrates exemplary operations for training a machine learning (ML) model for performing zero-shot classification under latency and resource constraints, in accordance with an embodiment of the disclosure;

FIG. 6 is a diagram that illustrates an exemplary knowledge base for generation of synthetic datasets using machine learning (ML) models for zero-shot classification, in accordance with an embodiment of the disclosure;

FIG. 7A is a diagram that illustrates an exemplary first user interface for performing zero-shot classification under latency and resource constraints, in accordance with an embodiment of the disclosure;

FIG. 7B is a diagram that illustrates an exemplary second user interface for performing zero-shot classification under latency and resource constraints, in accordance with an embodiment of the disclosure;

FIG. 8 is a diagram that illustrates a flowchart of an exemplary method for outputting a machine learning (ML) model for performing zero-shot classification under latency and resource constraints, in accordance with an embodiment of the disclosure; and

FIG. 9 is a diagram that illustrates a flowchart of an exemplary method for generation of synthetic datasets using machine learning (ML) models for zero-shot classification, in accordance with an embodiment of the disclosure.

### DETAILED DESCRIPTION

Zero-shot classification is a machine learning technique in which a machine learning model is designed to classify data without any labelled training data for those specific categories. Unlike traditional supervised learning methods that need extensive labelled datasets for training, zero-shot classification leverages semantic information to recognize and categorize data without prior exposure to specific classes. This is achieved through the use of models that can understand and generalize from descriptions or attributes of classes, enabling them to identify new, unseen categories.

The growth of zero-shot classification has been significantly influenced by the development of foundation models. These foundation models are trained on vast amounts of data, allowing them to generate human-like text and understand complex language patterns. Zero-shot classification can be applied to various tasks without the need for task-specific training data by leveraging the extensive knowledge encoded in these foundation models. This paradigm shift addresses the limitations of traditional supervised learning, which often relies on large, labelled datasets that are costly and time-consuming to obtain.

Zero-shot classification has found applications across various domains, including computer vision, natural language processing (NLP), and multimodal tasks. In NLP, zero-shot models can perform tasks such as sentiment analysis, text classification, and machine translation without task-specific training data. The versatility and efficiency of zero-shot classification make it a promising solution for many real-world applications, driving ongoing research and development in this field. Its ability to generalize from limited data and adapt to new, unseen scenarios continues to expand its potential uses across various industries.

Specifically, zero-shot classification has become increasingly valuable in scenarios where obtaining training data is challenging. This approach is particularly useful in fields like risk assessment on medical data and classification involving proprietary data, where access to extensive labelled datasets is often restricted due to privacy concerns or data scarcity. For instance, in medical risk assessment, zero-shot models can help identify potential health risks by leveraging existing medical knowledge and descriptions, even when specific training data for rare conditions is unavailable.

Moreover, zero-shot classification even excels in situations where unseen examples belong to categories which are not present in the training data. This capability is critical for tasks such as topic classification and business sentiment analysis. For example, in topic classification, a zero-shot model can accurately categorize new articles or documents into relevant topics based on their content, even if those topics were not explicitly included in the training set. Similarly, in business sentiment analysis, zero-shot models can analyze the sentiment of customer reviews or social media posts about new products or services, providing valuable insights without needing specific training data for each new product.

Traditional methods of performing zero-shot classification are majorly dependent on foundation models to generate synthetic data for training complex and resource-intensive classifiers. While foundation models enable zero-shot classification, they demand substantial computing resources and exhibit significant latency. This poses a challenge for applications that impose stringent constraints on latency and computational resources during inference. For instance, applications such as risk classification for health assistants, classification involving proprietary data, topic classification, and technologies involving edge intelligence that need rapid decision-making and efficient resource management, where even minor delays and inefficient resource management can be critical factors. Consequently, the high computational overhead and latency associated with these models render them impractical for such use cases. Moreover, the quality of synthetic data generated by the traditional methods can be insufficient to train the lightweight classifiers.

Therefore, there is a need for an improved approach to generating high-quality synthetic data to train lightweight classifiers for performing the zero-shot classification under stringent computing resources and latency constraints to solve the problems associated with the traditional methods of zero-shot classification.

The disclosed system aims to generate high-quality, diverse synthetic data that is needed to train lightweight classifiers for performing zero-shot classification under latency and resource constraints. In some embodiments, the disclosed system performs quality checks at various levels of the generation of synthetic data to ensure that the quality of the generated synthetic data is greater than or equal to a threshold quality score, which is needed to train these lightweight classifiers. The disclosed system can also perform the generation process in such a manner that high-quality synthetic data is generated in a short period of time which solves the problem of latency associated with the traditional methods.

In some embodiments, the disclosed system further enables the training of lightweight classifiers without having access to any labelled training data. The disclosed system can enable low latency inference by performing the generation of the synthetic data in such a manner that the synthetic data is generated in a short period of time. In some embodiments, the disclosed system further trains the lightweight classifiers, which can allow for performing zero-shot classification without the use of powerful resources such as GPUs or even powerful CPUs.

In some embodiments, the disclosed system enables zero-shot classification at applications that impose stringent constraints on latency and computational resources during inference. In some embodiments, the disclosed system performs zero-shot classification at applications such as risk classification for health assistants, classification involving proprietary data, and topic classification and the technologies involving edge intelligence that need rapid decision-making and efficient resource management, where even minor delays and inefficient resource management can be critical factors.

In various embodiments of the disclosure, a computer-implemented method for the generation of synthetic datasets using machine learning (ML) models for zero-shot classification is described. The computer-implemented method includes receiving, by a computer, a first input including a plurality of labels. The computer-implemented method further includes generating, by the computer, a first prompt associated with a first label of the plurality of labels. The computer-implemented method further includes applying, by the computer, a first ML model to the first prompt. The first ML model is a trained model. The computer-implemented method further includes generating, by the computer, a first set of labelled datapoints based on the application of the first ML model to the first prompt. The computer-implemented method further includes generating, by the computer, at least a first sub-prompt associated with at least one labelled datapoint of the first set of labelled datapoints. The first sub-prompt is different from the first prompt. The computer-implemented method further includes applying, by the computer, the first ML model to the at least first sub-prompt. The computer-implemented method further includes generating, by the computer, a first subset of labelled datapoints based on the application of the first ML model to the at least first sub-prompt. The first subset of labelled datapoints is different from the first set of labelled datapoints. The computer-implemented method further includes generating, by the computer, a training dataset based on the first set of labelled datapoints and the first subset of labelled datapoints. The computer-implemented method further includes outputting, by the computer, the generated training dataset. Therefore, the disclosed computer-implemented method may enable the generation of the training dataset for training lightweight classifiers (or a second ML model) without having the availability of task-specific labelled training data. Furthermore, the disclosed computer-implemented method may further enable zero-shot classification by generating the training dataset, which can be used to perform zero-shot classification.

In various embodiments of the disclosure, the computer-implemented method further includes applying, by the computer, a set of filters on the first set of labelled datapoints. The computer-implemented method further includes determining, by the computer, a quality score associated with the first set of labelled datapoints based on the application of the set of filters on the first set of labelled datapoints. The computer-implemented method further includes determining, by the computer, the quality score associated with the first set of labelled datapoints is greater than or equal to a threshold quality score. The computer-implemented method further includes generating, by the computer, the first sub-prompt for the first ML model based on the determination that the quality score associated with the first set of labelled datapoints is greater than or equal to the threshold quality score. Therefore, the disclosed computer-implemented method can include the application of the set of filters on the first set of labelled datapoints to remove unnecessary information, which can lead to the decrease in the quality score associated with the first set of labelled datapoints, from the first set of labelled datapoints. Moreover, the disclosed computer-implemented method may further ensure that the quality score is greater than or equal to the threshold quality score so that the quality of the training dataset is greater than or equal to the threshold quality score that is needed for training the lightweight classifiers that can perform zero-shot classification under latency and resource-constraints.

In various embodiments of the disclosure, the computer-implemented method further includes applying, by the computer, a set of filters on the first set of labelled datapoints. The computer-implemented method further includes determining, by the computer, a quality score associated with the first set of labelled datapoints based on the application of the set of filters on the first set of labelled datapoints. The computer-implemented method further includes determining, by the computer, the quality score associated with the first set of labelled datapoints is less than the threshold quality score. The computer-implemented method further includes modifying, by the computer, the first prompt based on the determination that the quality score associated with the first set of labelled datapoints is less than the threshold quality score. The computer-implemented method further includes applying, by the computer, the first ML model to the modified first prompt. Therefore, the disclosed computer-implemented method can generate the modified first prompt to remove the set of error values in the first set of labelled datapoints to ensure that there are no error values in the first set of labelled datapoints. This can lead to the generation of high-quality labelled datasets.

In various embodiments of the disclosure, the computer-implemented method further includes determining, by the computer, a quality score associated with the first subset of labelled datapoints. The computer-implemented method further includes comparing, by the computer, the quality score with a threshold quality score. The computer-implemented method further includes outputting, by the computer, the training dataset based on the comparison. The disclosed computer-implemented method may ensure that the quality score associated with the first subset of labelled datapoints is greater than or equal to the threshold quality score based on the comparison so that the quality of the training dataset is greater than or equal to the threshold quality score that is needed for training lightweight classifiers that can perform zero-shot classification under latency and resource-constraints.

In various embodiments of the disclosure, the quality score corresponds to one of a confidence score associated with the first subset of labelled datapoints or a perplexity score associated with the first subset of labelled datapoints. The disclosed computer-implemented method includes determining the quality score in terms of the confidence score of the first ML model in generating the first subset of labelled datapoints or a perplexity score of the first ML model in generating the first subset of labelled datapoints. The disclosed computer-implemented method includes outputting the training dataset based on the determination that the confidence score is greater than or equal to a threshold confidence score or based on the determination that the perplexity score is less than or equal to the threshold perplexity score. This may solve the problems associated with latency constraints. Therefore, the disclosed computer-implemented method may ensure that at least one quality score is fulfilled so that the quality of the generated training dataset is high enough to output the desired results.

In various embodiments of the disclosure, the computer-implemented method further includes determining, by the computer, that a first count of labelled datapoints in the training dataset is greater than or equal to a count threshold. The computer-implemented method further includes outputting, by the computer, the training dataset based on the determination that the first count of labelled datapoints in the training dataset is greater than or equal to the count threshold. The disclosed computer-implemented method may ensure that the first count of labelled datapoints in the training dataset is greater than or equal to the count threshold which further ensures that there are enough labelled datapoints in the training dataset which is needed to train the lightweight classifiers for performing zero-shot classification under latency and resource constraints. This may be done to ensure that the performance of the lightweight classifiers is high as it has been observed that if the count of labelled datapoints in the training dataset is less than the count threshold, then the performance of the lightweight classifiers trained on such training dataset is undesirable.

In various embodiments of the disclosure, the computer-implemented method further includes determining, by the computer, that a first count of labelled datapoints in the training dataset is less than a count threshold. The computer-implemented method further includes generating, by the computer, a second prompt associated with a second label of the plurality of labels based on the determination that the first count of labelled datapoints in the training dataset is less than the count threshold. The computer-implemented method further includes applying, by the computer, the first ML model to the second prompt. The computer-implemented method further includes generating, by the computer, a second set of labelled datapoints based on the application of the first ML model to the second prompt. The computer-implemented method further includes generating, by the computer, a second sub-prompt associated with at least one labelled datapoint of the second set of labelled datapoints. The second sub-prompt is different from the second prompt. The computer-implemented method further includes applying, by the computer, the first ML model to the second sub-prompt. The computer-implemented method further includes generating, by the computer, a second subset of labelled datapoints based on the application of the first ML model to the second sub-prompt. The second subset of labelled datapoints is different from the second set of labelled datapoints. The computer-implemented method further includes generating, by the computer, the training dataset based on the second set of labelled datapoints and the second subset of labelled datapoints. The disclosed computer-implemented method includes determining if the first count of labelled datapoints in the training dataset is less than the count threshold. Generating the second set of labelled datapoints and the second subset of labelled datapoints for generating the training dataset can ensure that there are enough labelled datapoints in the training dataset which is needed to train the lightweight classifiers for performing zero-shot classification under latency and resource constraints. Hence, the disclosed computer-implemented method can use hierarchical programmatic prompting to generate enough labelled datapoints in the training dataset.

In various embodiments of the disclosure, the computer-implemented method further includes determining, by the computer, that a second count of labelled datapoints in the training dataset is greater than the count threshold. The training dataset includes the first set of labelled datapoints, the first subset of labelled datapoints, the second set of labelled datapoints, and the second subset of labelled datapoints. The computer-implemented method further includes outputting, by the computer, the training dataset based on the determination that the second count of labelled datapoints in the training dataset is greater than the count threshold. The disclosed computer-implemented method may ensure that the second count of labelled datapoints in the training dataset is greater than or equal to the count threshold, which further ensures that there are enough labelled datapoints in the training dataset which is needed to train the lightweight classifiers for performing zero-shot classification under latency and resource constraints.

In various embodiments of the disclosure, the computer-implemented method further includes applying, by the computer, one or more data processing techniques on the first set of labelled datapoints and the first subset of labelled datapoints. The one or more data processing techniques include at least one of a data deduplication technique or a data sanitization technique. The computer-implemented method further includes generating, by the computer, the training dataset based on the application of the one or more data processing techniques on the first set of labelled datapoints and the first subset of labelled datapoints. Applying the one or more data processing techniques can ensure that there is no redundant labelled datapoint or incorrectly labelled datapoint in the training dataset which can reduce the quality of the training dataset and ultimately lead to undesirable classification results.

In various embodiments of the disclosure, the computer-implemented method further includes training, by the computer, a second ML model based on the training dataset. The second ML model is trained to classify a second input into at least one label of the plurality of labels. Training the second ML model on the high-quality training dataset may ensure that the second ML model can perform zero-shot classification under latency and resource constraints.

In various embodiments of the disclosure, the computer-implemented method further includes tuning one or more hyper-parameters associated with the second ML model based on the training dataset. Tuning the one or hyperparameters can ensure that the second ML model is tuned accordingly to generate desirable results.

In various embodiments of the disclosure, the computer-implemented method further includes receiving, by the computer, the second input from a user device. The computer-implemented method further includes applying, by the computer, the second ML model to the second input. The computer-implemented method further includes classifying, by the computer, the second input into the at least one label of the plurality of labels based on the application of the second ML model to the second input. The computer-implemented method further includes rendering, by the computer, the at least one label of the plurality of labels on the user device. The disclosed computer-implemented method can provide an interface for the user to interact with the trained second ML model by receiving the second input from the user device and rendering the at least one label of the plurality of labels on the user device. This may also enhance the user experience and provide a mechanism for the user to check the performance of the trained second ML model.

In various embodiments of the disclosure, the computer-implemented method further includes partitioning, by the computer, the first set of labelled datapoints and the first subset of labelled datapoints into the training dataset and a validation dataset. The computer-implemented method further includes training, by the computer, the second ML model based on the training dataset. The computer-implemented method further includes validating, by the computer, the second ML model based on the validation dataset. The computer-implemented method further includes determining, by the computer, a performance score based on the validation. The performance score is associated with one or more performance metrics of the second ML model. The computer-implemented method further includes outputting, by the computer, the second ML model. Partitioning the first set of labelled datapoints and the first subset of labelled datapoints can ensure that there are enough labelled datapoints in both the training dataset and the validation dataset for performing both the training of the second ML model and the validation of the second ML model. The validation of the machine learning model using the validation dataset can be critical to preventing overfitting, as it assesses the model's ability to generalize to unseen data. Furthermore, the validation can aid in hyperparameter tuning to provide an estimate of real-world performance.

In various embodiments of the disclosure, the one or more performance metrics correspond to at least one of an accuracy of the second ML model, a precision of the second ML model, a recall of the second ML model, or a confusion matrix of the second ML model. Therefore, the disclosed computer-implemented method may ensure the usage of multiple of one or more performance metrics to ensure that the output of the second ML model is desirable (precise and accurate).

In various embodiments of the disclosure, a computer system for the generation of synthetic datasets using machine learning (ML) models for zero-shot classification is described. The computer system includes a processor set, one or more computer-readable storage media, and program instructions stored on the one or more computer-readable storage media. The program instructions are executable by the processor set and cause the processor set to receive a first input that includes a plurality of labels. The program instructions further cause the processor set to generate a first prompt associated with a first label of the plurality of labels. The program instructions further cause the processor set to apply a first machine learning (ML) model to the first prompt. The first ML model is a trained model. The program instructions further cause the processor set to generate a first set of labelled datapoints based on the application of the first ML model to the first prompt. The program instructions further cause the processor set to generate at least a first sub-prompt associated with at least one labelled datapoint of the first set of labelled datapoints. The first sub-prompt is different from the first prompt. The program instructions further cause the processor set to apply the first ML model to the at least first sub-prompt. The program instructions further cause the processor set to generate a first subset of labelled datapoints based on the application of the first ML model to the at least first sub-prompt. The first subset of labelled datapoints is different from the first set of labelled datapoints. The program instructions further cause the processor set to generate a training dataset based on the first set of labelled datapoints and the first subset of labelled datapoints. The program instructions further cause the processor set to train a second ML model based on the training dataset. The second ML model is trained to classify a second input into at least one label of the plurality of labels. The program instructions further cause the processor set to output the second ML model. The disclosed system can enable the generation of the training dataset without having the availability of task-specific labelled training data. The disclosed system can further enable zero-shot classification by generating the training dataset, which can be used to perform zero-shot classification. Furthermore, the disclosed system may further enable the training of the second ML model on the training dataset without having the availability of any available labelled training data.

In various embodiments of the disclosure, the program instructions further cause the processor set to determine a quality score associated with the first subset of labelled datapoints. The quality score corresponds to one of a confidence score associated with the first subset of labelled datapoints or a perplexity score associated with the first subset of labelled datapoints. The program instructions further cause the processor to compare the quality score with a threshold quality score. The program instructions further cause the processor to output the training dataset based on the comparison. The disclosed system may ensure that the quality score associated with the first subset of labelled datapoints is greater than or equal to the threshold quality score based on the comparison so that the quality of the training dataset is greater than or equal to the threshold quality score that is needed for training lightweight classifiers which can perform zero-shot classification under latency and resource-constraints.

In various embodiments of the disclosure, the program instructions further cause the processor set to determine a first count of labelled datapoints in the training dataset is greater than or equal to a count threshold. The program instructions further cause the processor to output the training dataset based on the determination that the first count of labelled datapoints in the training dataset is greater than or equal to the count threshold. The disclosed system may ensure that the first count of labelled datapoints in the training dataset is greater than or equal to the count threshold which further ensures that there are enough labelled datapoints in the training dataset which is needed to train the lightweight classifiers for performing zero-shot classification under latency and resource constraints. This may be done to ensure that the performance of the lightweight classifiers is high as it has been observed that if the count of labelled datapoints in the training dataset is less than the count threshold, then the performance of the lightweight classifiers trained on such training dataset is undesirable.

In various embodiments of the disclosure, the program instructions further cause the processor set to determine a first count of labelled datapoints in the training dataset is less than a count threshold. The program instructions further cause the processor to generate a second prompt associated with a second label of the plurality of labels based on the determination that the first count of labelled datapoints in the training dataset is less than the count threshold. The program instructions further cause the processor to apply the first ML model to the second prompt. The program instructions further cause the processor to generate a second set of labelled datapoints based on the application of the first ML model to the second prompt. The program instructions further cause the processor to generate a second sub-prompt associated with at least one labelled datapoint of the second set of labelled datapoints. The second sub-prompt is different from the second prompt. The program instructions further cause the processor to apply the first ML model to the second sub-prompt. The program instructions further cause the processor to generate a second subset of labelled datapoints based on the application of the first ML model to the second sub-prompt. The second subset of labelled datapoints is different from the second set of labelled datapoints. The program instructions further cause the processor to generate the training dataset based on the second set of labelled datapoints and the second subset of labelled datapoints. The disclosed system checks if the first count of labelled datapoints in the training dataset is less than the count threshold. If the count of labelled datapoints in the training dataset is less than the count threshold, then the disclosed system generates the second set of labelled datapoints and the second subset of labelled datapoints for generating the training dataset to ensure that there are enough labelled datapoints in the training dataset which is needed to train the lightweight classifiers for performing zero-shot classification under latency and resource constraints. Hence, the disclosed system uses hierarchical programmatic prompting to generate enough labelled datapoints in the training dataset.

In various embodiments of the disclosure, the program instructions further cause the processor set to determine a second count of labelled datapoints in the training dataset is greater than the count threshold. The training dataset includes the first set of labelled datapoints, the first subset of labelled datapoints the second set of labelled datapoints, and the second subset of labelled datapoints. The program instructions further cause the processor set to output the training dataset based on the determination that the second count of labelled datapoints in the training dataset is greater than the count threshold. The disclosed system may ensure that the second count of labelled datapoints in the training dataset is greater than or equal to the count threshold, which further ensures that there are enough labelled datapoints in the training dataset which is needed to train the lightweight classifiers for performing zero-shot classification under latency and resource constraints.

In various embodiments of the disclosure, a computer program product for the generation of synthetic datasets using machine learning (ML) models for zero-shot classification is described. The computer program product includes one or more computer-readable storage media and program instructions stored in the one or more computer-readable storage media to perform operations that include receiving a first input that includes a plurality of labels. The operations further include generating a first prompt associated with a first label of the plurality of labels. The operations further include applying a first ML model to the first prompt. The first ML model is a trained model. The operations further include generating a first set of labelled datapoints based on the application of the first ML model to the first prompt. The operations further include generating at least a first sub-prompt associated with at least one labelled datapoint of the first set of labelled datapoints. The first sub-prompt is different from the first prompt. The operations further include applying the first ML model to the at least first sub-prompt. The operations further include generating a first subset of labelled datapoints based on the application of the first ML model to the at least first sub-prompt. The first subset of labelled datapoints is different from the first set of labelled datapoints. The operations further include generating a training dataset based on the first set of labelled datapoints and the first subset of labelled datapoints. The operations further include outputting the generated training dataset. The disclosed computer program product can enable the generation of the training dataset without having the availability of task-specific labelled training data. The disclosed computer program product may further enable zero-shot classification by generating the training dataset, which can be used to perform zero-shot classification.

In various embodiments of the disclosure, the at least first sub-prompt associated with at least one labelled datapoint of the first set of labelled datapoints is generated using knowledge graphs and ontology trees of existing knowledge bases associated with each label of the plurality of labels.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or various freely propagating electromagnetic waves, electromagnetic waves propagating through a waveguide, light pulses passing through a fiber optic cable, electrical signals communicated through a wire, and/or various transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

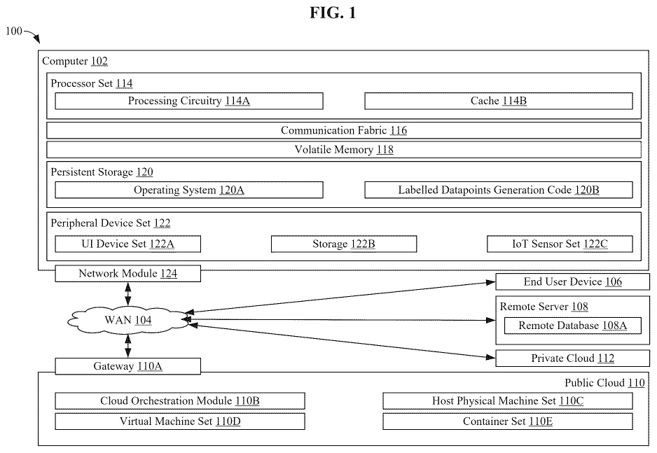

FIG. 1 is a diagram that illustrates a computing environment for generation of synthetic datasets using machine learning (ML) models for zero-shot classification, in accordance with an embodiment of the disclosure. With reference to FIG. 1, there is shown a computing environment 100 that contains an example of an environment for the execution of at least some of the computer code involved in performing the disclosed methods, such as a labelled datapoints generation code 120B. In addition to the labelled datapoints generation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the labelled datapoints generation code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not needed to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the labelled datapoints generation code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not needed unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the labelled datapoints generation code 120B typically includes at least some of the computer code involved in performing the disclosed methods.

The peripheral device set 122 includes the set of peripheral devices of computer 102. Data communication connections between the peripheral devices and the various components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is needed to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows computer 102 to communicate with various computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network.

The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize various resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

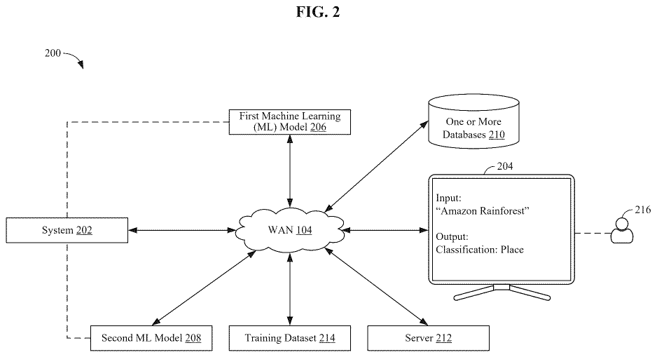

FIG. 2 is a diagram that illustrates an environment for generation of synthetic datasets using machine learning (ML) models for zero-shot classification, in accordance with an embodiment of the disclosure. FIG. 2 is explained in conjunction with elements from FIG. 1. With reference to FIG. 2, there is shown a diagram of a network environment 200. The network 0098 US environment 200 includes a computer system 202, a user device 204, a first Machine Learning (ML) model 206, and a second ML model 208. The network environment 200 further includes one or more databases 210, a server 212, a training dataset 214, and a user 216 associated with the user device 204. The network environment 200 further includes the WAN 104 of FIG. 1. In an embodiment of the disclosure, the user device 204 is an exemplary embodiment of the EUD 106. Similarly, the computer system 202 is an exemplary embodiment of the computer 102 in FIG. 1.

The computer system 202 includes suitable logic, circuitry, and/or interfaces for generation of synthetic datasets using ML models for zero-shot classification. The computer system 202 receives a first input that includes a plurality of labels. The computer system 202 further generates a first prompt associated with a first label of the plurality of labels. The computer system 202 further applies the first ML model 206 to the first prompt. The first ML model 206 is a trained model. The computer system 202 further generates a first set of labelled datapoints based on the application of the first ML model 206 to the first prompt. The computer system 202 further generates at least a first sub-prompt associated with at least one labelled datapoint of the first set of labelled datapoints. The computer system 202 further applies the first ML model 206 to the at least first sub-prompt. The computer system 202 further generates a first subset of labelled datapoints based on the application of the first ML model 206 to the at least first sub-prompt. The computer system 202 further generates the training dataset 214 based on the first set of labelled datapoints and the first subset of labelled datapoints. The computer system 202 further outputs the training dataset 214.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. By way of example, and not by limitation, the computer system 202 may be embodied as a cloud-based service, a cloud-based application, a cloud-based platform, a remote server-based service, a remote server-based application, a remote server-based platform, or a virtual computing system.

The user device 204 includes suitable logic, circuitry, and/or interfaces that are configured to execute one or more tasks within the network environment 200. The user device 204 performs the one or more tasks such as receiving data, processing the data, and transmitting the data. In an embodiment of the disclosure, the computer system 202 receives the first input that includes the plurality of labels via the user device 204. In an embodiment of the disclosure, the computer system 202 receives a second input from the user device 204. In an embodiment of the disclosure, the computer system 202 renders at least one label of the plurality of labels and the generated training dataset 214 on the user device 204. Examples of the user device 204 include one of but are not limited to, a smartphone, a cellular phone, a mobile phone, a consumer electronic (CE) device, an Internet of Things (IOT) device, a computing device, a mainframe machine, a server, a computer workstation, or the like.

The first ML model 206 may be a sophisticated piece of software that leverages natural language processing (NLP) and machine learning techniques to understand, generate, and manipulate human language. For example, the first ML model 206 may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

For example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. For example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to a large number of parameters, training of LLMs from scratch is a time-consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted that a base model in an LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping the base model's parameters frozen. In particular, the adapter is used to fine-tune the base model for a specific downstream task without extensively modifying its pre-trained parameters. This approach is beneficial when computational resources or labelled task-specific data are limited.

In an embodiment of the disclosure, the first ML model 206 generates the first set of labelled datapoints based on the first prompt that may be provided as a first input to the first ML model 206. In an embodiment of the disclosure, the first ML model 206 further generates the first subset of labelled datapoints based on the first sub-prompt, which may be provided as a second input to the first ML model 206. In an embodiment of the disclosure, the computer system 202 stores the first ML model 206. In an alternate embodiment of the disclosure, the first ML model 206 is embodied as a cloud-based service, a cloud-based application, or a cloud-based platform.

The second ML model 208 corresponds to a neural network-based classifier. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of the nodes in the input layer may be coupled to at least one node of the hidden layer(s). Similarly, the inputs of each hidden layer are coupled to outputs of at least one node in various layers of the neural network. Outputs of each hidden layer may be coupled to inputs of at least one node in various layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on the training dataset 214. Each node of the neural network corresponds to a mathematical function (e.g., a sigmoid 2 function or a rectified linear unit) with a set of parameters, tunable during the training of the neural network. The set of parameters includes, for example, a weight parameter, a regularization parameter, and the like. Each node uses the mathematical function to compute an output based on one or more inputs from nodes in various layer(s) (e.g., previous layer(s)) of the neural network. Each node of the nodes of the neural network corresponds to the same or a different mathematical function.

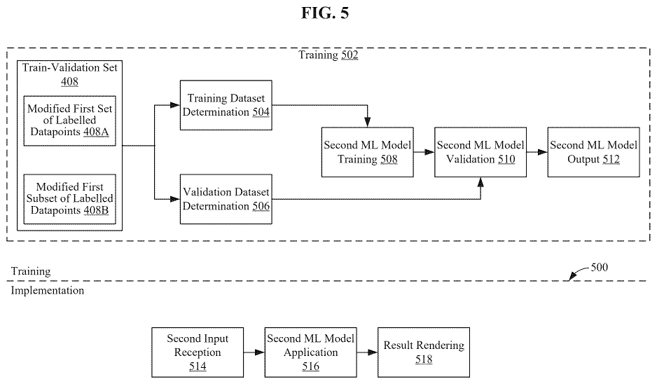

In the training of the second ML model 208, one or more parameters of each node of the second ML model 208 may be updated based on whether an output of the final layer for a given input (from the training dataset 214) matches a correct result based on a loss function for the second ML model 208. The above process may be repeated for the same or a different input until a minima of loss function may be achieved, and a training error may be minimized. Details about the training of the second ML model 208 are provided in, for example, FIG. 5.

The neural network includes electronic data, such as, for example, a software program, code of the software program, libraries, applications, scripts, or various logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the second ML model 208 is a separate entity in the computer system 202, without deviation from the scope of the disclosure.

In an embodiment of the disclosure, the computer system 202 trains the second ML model 208 for classifying the second input into at least one label of the plurality of labels. The computer system 202 trains the second ML model 208 for classifying the second input into at least one label of the plurality of labels based on the generated training dataset 214. Details about the training of the second ML model 208 are provided, for example, in FIG. 5. In an embodiment of the disclosure, the computer system 202 stores the second ML model 208. In an alternate embodiment of the disclosure, the second ML model 208 is embodied as a cloud-based service, a cloud-based application, or a cloud-based platform.

Examples of the second ML model 208, include one of, but are not limited to, a multinomial naive bayes model, an artificial neural network (ANN), a deep neural network (DNN), a convolutional neural network (CNN), a fully connected neural network, and/or a combination of such networks.

Each of the one or more databases 210 corresponds to an organized collection of data that is stored and accessed electronically from a computer system (such as the computer system 202 or the computer 102). Each of the one or more databases 210 is designed to manage, store, retrieve, and update data efficiently. The structure of the database 210 typically involves tables, records, and fields that can be managed through various database management systems (DBMS). In an embodiment of the disclosure, each of the one or more databases 210 stores the plurality of labels.

In an embodiment of the disclosure, each of the one or more databases 210 stores the training dataset 214 and the classified second input. In an embodiment of the disclosure, each of the one or more databases 210 stores the first ML model 206 and the second ML model 208. In an embodiment of the disclosure, each of the one or more databases 210 stores knowledge graphs and ontology trees of existing knowledge bases that may be associated with each label of the plurality of labels. Examples of each of the one or more databases 210 include but are not limited to, a relational database, a Non-Structured Query Language (SQL) database, a hierarchical database, a network database, a transactional database, a data warehouse, and a distributed database.

The server 212 includes suitable logic, circuitry, interfaces, and/or code that stores the plurality of labels and the training dataset 214. The server 212 stores the first ML model 206, and the second ML model 208. The server 212 can be implemented as a cloud server and may execute operations through web applications, cloud applications, HTTP requests, repository operations, file transfer, and the like. Various example implementations of the server 212 include but are not limited to, a database server, a file server, a web server, a media server, an application server, a mainframe server, or a cloud computing server.

In an embodiment of the disclosure, the server 212 is implemented as a plurality of distributed cloud-based resources by use of several technologies that are well known to those ordinarily skilled in the art. A person with ordinary skill in the art will understand that the scope of the disclosure may not be limited to the implementation of the server 212 and the computer system 202 as two separate entities. In certain embodiments, the functionalities of the server 212 can be incorporated in its entirety or at least partially in the computer system 202, without a departure from the scope of the disclosure.

In operation, the computer system 202 receives the plurality of labels. In an embodiment of the disclosure, the second ML model 208 is to be trained by the computer system 202 to classify the second input into at least one label of the plurality of labels. In an embodiment of the disclosure, the computer system 202 receives the plurality of labels from the user device 204. In an alternate embodiment of the disclosure, the computer system 202 retrieves the plurality of labels from the database 210. By way of example, and not by limitation, the computer system 202 receives the plurality of labels including a first label, a second label, and a third label. By way of example and not limitation, the first label may be “people”, the second label may be “places”, and the third label may be “organizations”. The computer system 202 receives the plurality of labels from the user device 204. The second ML model 208 is to be trained to classify the second input into at least one label from “people”, “places” or “organization”.

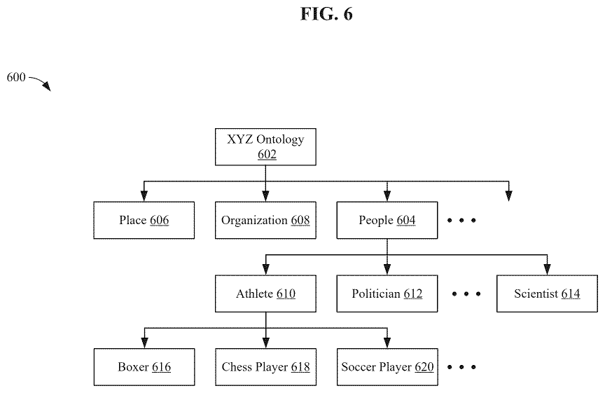

Thereafter, the computer system 202 generates the first prompt associated with the first label of the plurality of labels. In an embodiment of the disclosure, the computer system 202 generates the first prompt based on a pre-defined template associated with the generation of one or more prompts. In an embodiment of the disclosure, the computer system 202 populates the pre-defined template associated with the generation of one or more prompts with data from the first label of the plurality of labels to generate the first prompt. In an alternate embodiment of the disclosure, the computer system 202 generates the first prompt based on a traversal of the knowledge graphs and the ontology trees of the existing knowledge bases associated with the plurality of labels. Details about the ontology trees are provided, for example, in FIG. 6.

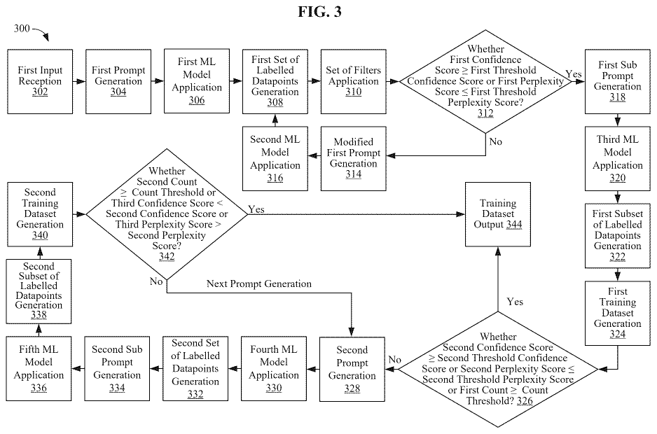

In an alternate embodiment of the disclosure, the computer system 202 provides each label of the plurality of labels, as an input, to the first ML model 206 for generating the first prompt associated with the corresponding label of the plurality of labels. Details about the generation of prompts are provided, for example, in FIG. 3.

As a first example, the computer system 202 generates the first prompt for the first label as “generate a numbered list containing names of 5 people”. Further, the computer system 202 applies the first ML model 206 to the first prompt. The first ML model 206 is a trained model that analyzes the first prompt corresponding to the first label of the plurality of labels. The first ML model 206 further identifies patterns and relationships in the first prompt associated with the first label of the plurality of labels based on its training data to generate a response to the first prompt. With reference to the first example, the first ML model 206 generates a first numbered list containing names of 5 people as “1. John, 2. Peter, 3. William, 4. Kartik, 5. Kane”.

Thereafter, the computer system 202 generates the first set of labelled datapoints based on the application of the first ML model 206 to the first prompt. The computer system 202 analyzes the response of the first ML model 206 based on the first prompt associated with the first label of the plurality of labels to generate the first set of labelled datapoints. In an embodiment of the disclosure, a labelled datapoint may be a single unit of data that includes both input features and an output label. The first set of labelled datapoints includes at least one labelled datapoint associated with the first label of the plurality of labels. With reference to the first example, the first set of labelled datapoints includes “John: People, Peter: People, William: People, Kartik: People, Kane: People”.

Further, the computer system 202 generates the first sub-prompt associated with at least the one labelled datapoint of the first set of labelled datapoints. In an embodiment of the disclosure, the computer system 202 generates the first sub-prompt associated with at least the one labelled datapoint of the first set of labelled datapoints based on the application of a set of filters. The first sub-prompt is different from the first prompt. Further, the computer system 202 generates the first sub-prompt based on populating the predefined template associated with the generation of prompts with data from at least the one labelled datapoint to generate the first prompt. In an alternate embodiment, the computer system 202 generates the first sub-prompt based on the traversal of the knowledge graphs and the ontology trees of existing knowledge bases. Details about the set of filters are provided, for example, in FIG. 3.

By way of example, and not by limitation, the computer system 202 generates the first sub-prompt associated with the at least one labelled datapoint of the generated first set of labelled datapoints. With reference to the first example, the first sub-prompt may be “generate a numbered list containing names of 5 people associated with John”. Similarly, the computer system 202 further generates the first sub-prompt in a hierarchical manner for the one or more labelled datapoints of the first set of labelled datapoints starting from the datapoint “Peter” and excluding the datapoint “John”.

Thereafter, the computer system 202 applies the first ML model 206 to the first sub-prompt. The first ML model 206 analyzes the first sub-prompt associated with at least the one labelled datapoint of the first set of labelled datapoints. The first ML model 206 further identifies patterns and relationships in the first sub-prompt based on its training data to generate a response to the first sub-prompt. By way of example, and not by limitation, the first ML model 206 generates a first numbered list “1. Sam is also an athlete like John 2. Edwards is in the opposition team of John 3. Rahul is the coach of the team in which John plays 4. Henry is the coach of the opposition team of John 5. Smith is the captain of the team in which John plays”. Similarly, the first ML model 206 generates a numbered list based on the first sub-prompt associated with the corresponding labelled datapoint in the first set of labelled datapoint, for example, “Peter”.

Further, the computer system 202 generates the first subset of labelled datapoints based on the application of the first ML model 206 to the first sub-prompt. The first subset of labelled datapoints is different from the first set of labelled datapoints. The computer system 202 analyzes the response of the first ML model 206 based on the first sub-prompt associated with at least the one labelled datapoint of the first set of labelled datapoints to generate the first subset of labelled datapoints. By way of example, and not by limitation, the first subset of labelled datapoints includes “Sam: People, Edwards: People, Rahul: People, Henry: People, Smith: People”. Similarly, the computer system 202 generates the first subset of labelled datapoints corresponding to each labelled datapoints from the first set of labelled datapoints in a hierarchical manner.

Thereafter, the computer system 202 generates the training dataset 214 based on the first set of labelled datapoints and the first subset of labelled datapoints. The computer system 202 combines the first set of labelled datapoints and the first subset of labelled datapoints to generate the training dataset 214. By way of example, and not by limitation, the training dataset 214 includes “John: People, Peter: People, William: People, Kartik: People, Kane: People, Sam: People, Edwards: People, Rahul: People, Henry: People, Smith: People”. Similarly, the training dataset 214 may further include each labelled datapoint of the first subset of the labelled datapoints. Each labelled datapoint of the first subset of labelled datapoints is generated based on the corresponding labelled datapoints of the first set of labelled datapoints.

To this end, the computer system 202 further outputs the training dataset 214. The computer system 202 further outputs the training dataset 214 for training the second ML model 208 to classify the second input into at least one label of the plurality of labels. In an embodiment of the disclosure, a quality score associated with the generated training dataset 214 is greater than a threshold quality score which is needed for training the second ML model 208 (lightweight classifier). The quality score of the generated training dataset 214 being greater than the threshold quality score ensures that the quality of the generated training dataset 214 (for e.g., the generated synthetic data) is greater than or equal to the threshold quality score that is needed to train the second ML model for performing the zero-shot classification under latency and resource-constraints. Details about the training of the second ML model 208 are provided, for example, in FIG. 5

FIG. 3 is a block diagram 300 that illustrates exemplary operations for generation of synthetic datasets using machine learning (ML) models for zero-shot classification, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 344, as described herein. The exemplary operations illustrated in the block diagram 300 start at 302 and are performed by any computing system, apparatus, or device, such as by the computer 102 of FIG. 1 or by the computer system 202 of FIG. 2. With reference to FIG. 3, there is further shown the second ML model 208. Although illustrated with discrete blocks, the exemplary operations associated with one or more blocks of the block diagram 300 can be divided into additional blocks, combined into fewer blocks, or eliminated, depending on the implementation.

At 302, a first input reception operation is performed. In the first input reception operation, the computer system 202 receives the first input that includes the plurality of labels. In an embodiment of the disclosure, the second ML model 208 is to be trained by the computer system 202 to classify the second input into at least one label of the plurality of labels. In an embodiment of the disclosure, the computer system 202 receives the plurality of labels from the user device 204. In an alternate embodiment of the disclosure, the computer system 202 retrieves the plurality of labels from the database 210. The plurality of labels includes a first label, a second label, a third label, up to an Nth label. By way of example, and not by limitation, the computer system 202 receives the plurality of labels including the first label, the second label, and the third label. The first label may be “people”, the second label may be “place”, and the third label may be “organization”. Consequently, the computer system 202 may train the second ML model 208 to classify the second input into at least one label from “people”, “place” or “organization”.

At 304, a first prompt generation operation is performed. In the first prompt generation operation, the computer system 202 generates the first prompt associated with the first label of the plurality of labels. In an embodiment of the disclosure, the computer system 202 generates the first prompt based on the pre-defined template associated with the generation of one or more prompts. The computer system 202 populates the predefined template associated with the generation of one or more prompts with data from the first label of the plurality of labels to generate the first prompt. For example, the predefined template associated with the generation of prompts is “generate a numbered list containing names of {n} {entity}” which is used to generate “n” datapoints of an entity. The computer system 202 populates the entity based on the first label of the plurality of labels.

In an alternate embodiment of the disclosure, the computer system 202 generates the first prompt based on a traversal of the knowledge graphs and the ontology trees of the existing knowledgebases associated with the plurality of labels. Specifically, the computer system 202 obtains these knowledge graphs and the ontology tress of existing knowledgebases from the database 210 and then traverses the existing knowledgebases to generate the first prompt. Details about the generation of prompts using traversal of ontology trees and knowledge graphs are provided in, for example, FIG. 6.

In an alternate embodiment of the disclosure, the computer system 202 provides each label of the plurality of labels to the first ML model 206 for generating the first prompt associated with the corresponding label of the plurality of labels. By way of example, and not by limitation, the computer system 202 generates the first prompt for the first label as “generate a numbered list containing names of 5 people”.

At 306, a first ML model application operation is performed. In the first ML model application operation, the computer system 202 applies the first ML model 206 to the first prompt. The first ML model 206 is a trained model. The first ML model 206 analyzes the first prompt corresponding to the first label of the plurality of labels. The first ML model 206 further identifies patterns and relationships in the first prompt associated with the first label of the plurality of labels based on its training data to generate a response to the first prompt. By way of example, and not by limitation, the first ML model 206 generates a first numbered list “1. John, 2. Peter, 3. William, 4. Kartik 5. Kane” in response to the provided first prompt “generate a numbered list containing names of 5 people”.

At 308, a first set of labelled datapoints generation operation is performed. In the first set of labelled datapoints generation operation, the computer system 202 generates the first set of labelled datapoints based on the application of the first ML model 206 to the first prompt. The computer system 202 analyzes the response of the first ML model 206 based on the first prompt associated with the first label of the plurality of labels to generate the first set of labelled datapoints. The first set of labelled datapoints includes at least one labelled datapoint associated with the first label of the plurality of labels. In an embodiment of the disclosure, the first set of labelled datapoints includes, for example, but is not limited to, “John: People, Peter: People, William: People, Kartik: People, Kane: People”.

At 310, a set of filters application operations is performed. In the set of filters application operation, the computer system 202 applies a set of filters on the first set of labelled datapoints. The set of filters includes a set of rule-based filters and a set of policy-based filters. The set of rule-based filters and the set of policy-based filters are applied on the first set of labelled datapoints to determine the first quality score associated with the first set of labelled datapoints. The set of rule-based filters and the set of policy-based filters are further applied to the generated response of the first ML model 206 to the first prompt to check whether the generated response is in the correct format. The set of filters is applied on the first set of labelled datapoints to check whether the first quality score is above a first threshold quality score, which is needed for the generation of the first sub-prompt.

The set of rule-based filters can include at least a format check filter, a spell check filter, a uniqueness check filter, and the like. In an embodiment of the disclosure, the computer system 202 determines the first quality score based on the application of the uniqueness check filter, the format check filter, and the spell check filter on the first set of labelled datapoints. In an embodiment of the disclosure, the format check filter checks the format of the generated response. For example, if the first prompt is associated with generating a numbered list, then the generated response must include “1”. The format check filter further checks if the generated response includes the word “Sorry”, “Unavailable”, “Server Issue” or the like that may indicate that the response is not properly generated. The first quality score in that case will be zero. The spell check filter checks the spelling of each labelled datapoint in the first set of labelled datapoints. In an embodiment, the computer system 202 determines the first quality score based on a calculation of the number of incorrectly spelt labelled datapoints (the one or more labelled datapoints having an incorrect spelling) present in the first set of labelled datapoints.

The uniqueness check filter verifies that each labelled datapoint in the first set of labelled datapoints is unique. By way of example, and not by limitation, the computer system 202 may further apply the uniqueness check filter on the generated response. For example, if the first set of labelled datapoints includes specific datapoints “John: People, John: People, Sam: People”, then the computer system 202 verifies that “John: People” is repeating multiple times in the first set of labelled datapoints. In an embodiment, the computer system 202 determines the first quality score based on a calculation of the number of duplicate labelled datapoints (the one or more labelled datapoints having multiple occurrences) present in the first set of labelled datapoints.

The set of policy-based filters is applied to the generated first set of labelled datapoints to determine the first quality score associated with the generated first set of labelled datapoints. The set of policy-based filters is applied on the generated first set of labelled datapoints to check whether the first quality score is above the first threshold quality score which is needed for the generation of the first sub-prompt. In an embodiment of the disclosure, the computer system 202 determines the first quality score associated with the first set of labelled datapoints based on the application of the set of filters.

In an embodiment of the disclosure, the first quality score corresponds to a confidence score associated with the first set of labelled datapoints or a perplexity score associated with the first set of labelled datapoints. The confidence score associated with the first set of labelled datapoints is a numerical value that indicates the first ML model's level of certainty in its generated response. The perplexity score associated with the first set of labelled datapoints is a performance metric that is used to determine the first ML model's level of certainty in generating a sequence of words in the generated response. Mathematically, the perplexity score is the exponentiated average negative log-likelihood of the sequence of words in the generated response. In an embodiment of the disclosure, the computer system 202 determines the first quality score associated with the first set of labelled datapoints based on a calculation of a confidence score of the first ML model 206 associated with the generation of the first set of labelled datapoints. In an alternate embodiment of the disclosure, the computer system 202 determines the first quality score based on the calculation of a perplexity score of the first ML model 206 associated with the generation of the first set of labelled datapoints.

At 312, a first comparison operation is performed. In the first comparison operation, the computer system 202 determines whether the first quality score associated with the first set of labelled datapoints is greater than or equal to the first threshold quality score to ensure that the quality of the generated training dataset 214 in the end is high enough (greater than or equal to a threshold quality score) which is needed to train the second ML model 208 for performing zero-shot classification under latency and resource-constraints. In an embodiment of the disclosure, the computer system 202 determines whether the first confidence score associated with the first set of labelled datapoints is greater than or equal to the first threshold confidence score. In an alternate embodiment of the disclosure, the computer system 202 determines whether the first perplexity score associated with the first set of labelled datapoints is less than or equal to the first threshold perplexity score (since the lesser the perplexity score, the better is the quality score of the generated first set of labelled datapoints). The control of operations shifts to 318 based on the determination that the first confidence score associated with the first set of labelled datapoints is greater than or equal to the first threshold confidence score. Otherwise, the control of operations shifts to 314. In an alternate embodiment of the disclosure, the control of operations shifts to 318 based on the RUS determination that the first perplexity score associated with the first set of labelled datapoints is less than or equal to the first threshold perplexity score. Otherwise the control of operations shifts to 314.

At 314, a modified first prompt generation operation is performed. In the modified first prompt generation operation, the computer system 202 generates a modified first prompt based on the determination that the first quality score associated with the first set of labelled datapoints is less than the first threshold quality score. In an embodiment of the disclosure, the computer system 202 generates the modified first prompt based on the determination that the first confidence score is less than the first threshold confidence score. In an alternate embodiment of the disclosure, the computer system 202 generates the modified first prompt based on the determination that the first perplexity score is greater than the first threshold perplexity score. By way of example, and not by limitation, if the first set of labelled datapoints includes multiple repeated occurrences of a specific datapoint for example “John: People, John: People, Sam: People”, then the computer system 202 generates the modified first prompt “generate a numbered list containing names of 5 people and each of the names must be different from each other”. By way of example, and not by limitation, if the generated first set of labelled datapoints includes incorrectly spelt words, for example, “John: People, Sam: People”, then the computer system 202 generates the modified first prompt, “generate a numbered list containing names of 5 people and verify the spelling of each name before generating the numbered list”.

At 316, a second ML model application operation is performed. In the second ML model application operation, the computer system 202 applies the first ML model 206 to the modified first prompt. The first ML model 206 further identifies patterns and relationships in the modified first prompt based on its training data to generate a response to the modified first prompt “Generate a numbered list containing names of 5 people and each of the names must be different from each other”. By way of example, and not by limitation, the first ML model 206 generates a modified first numbered list, including no duplicates and no incorrectly spelt words, for example, “1. John, 2. Peter, 3. William, 4. Kartik 5. Kane”.

At 318, a first sub-prompt generation operation is performed. In the first sub-prompt generation operation, the computer system 202 generates the first sub-prompt for the first ML model 206 based on the determination that the first quality score associated with the first set of labelled datapoints is greater than the first threshold quality score. In an embodiment of the disclosure, the computer system 202 generates the first sub-prompt based on the determination that the first confidence score is greater than or equal to the first threshold confidence score. In an alternate embodiment of the disclosure, the computer system 202 generates the first sub-prompt based on a determination that the first perplexity score is less than or equal to the first threshold perplexity score. The first sub-prompt is associated with at least the one labelled datapoint of the first set of labelled datapoints. The first sub-prompt is different from the first prompt. In an embodiment of the disclosure, the computer system 202 generates the first sub-prompt based on populating the predefined template associated with the generation of one or more prompts. The computer system 202 populates the predefined template associated with the generation of one or more prompts with data from at least the one labelled datapoint to generate the first sub-prompt.

In an alternate embodiment of the disclosure, the computer system 202 generates the first sub-prompt based on the traversal of the knowledge graphs and the ontology trees of the existing knowledgebases associated with the plurality of labels. By way of example, and not by limitation, the computer system 202 generates the first prompt for the first label as “generate a numbered list containing names of 5 people associated with John”. Similarly, the computer system 202 further generates the first sub-prompt in a hierarchical manner for each labelled datapoint of the first set of labelled datapoints starting from the datapoint “Peter” and excluding the datapoint “John”. By way of example, and not by limitation, the computer system 202 generates the first sub-prompt that corresponds to “Peter”, for example, as “generate a numbered list containing names of 5 people associated with Peter”.

At 320, a third ML model application operation is performed. In the third ML model application operation, the computer system 202 applies the first ML model 206 to the first sub-prompt. The first ML model 206 further identifies patterns and relationships in the first sub-prompt based on its training data to generate a response to the first sub-prompt. By way of example, and not by limitation, the first ML model 206 generates a first numbered list “1. Sam is also an athlete like John 2, Edwards is in the opposition team of John, 3. Rahul is the coach of the team in which John Plays, 4. Henry is the coach of the opposition team of John 5, Smith is the captain of the team in which John plays”.

Similarly, the first ML model 206 generates a numbered list based on the first sub-prompt associated with the corresponding labelled datapoint in the first set of labelled datapoint. By way of example, and not by limitation, the numbered list corresponding to Peter may be, for example, “1. Robert is a politician of the same party as Peter, 2. Lisa is a politician of the opposition party to Peter, 3. Parth is the leader of the political party of Peter, 4. Jason is the leader of the opposition party to Peter, 5. Emily is also a politician like Peter”. Similarly, the numbered list is generated for the first sub-prompt associated with various corresponding labelled datapoints.

At 322, a first subset of labelled datapoints generation operation is performed. In the first subset of labelled datapoints generation operation, the computer system 202 generates the first subset of labelled datapoints based on the application of the first ML model 206 to the first sub-prompt. The first subset of labelled datapoints is different from the first set of labelled datapoints. The computer system 202 analyzes the response of the first ML model 206 based on the first sub-prompt associated with at least the one labelled datapoint of the first set of labelled datapoints to generate the first subset of labelled datapoints. By way of example, and not by limitation, the first subset of labelled datapoints corresponding to “John” includes, for example, “Sam: People, Edwards: People, Rahul: People, Henry: People, Smith: People”.

Similarly, the computer system 202 generates the first subset of labelled datapoints corresponding to each labelled datapoints from the first set of labelled datapoints in a hierarchical manner. By way of example, and not by limitation, the first subset of labelled datapoints corresponding to “Peter” includes, for example, “Robert: People, Lisa: People, Parth: People, Jason: People, Emily: People”. In this manner, the computer system 202 hierarchically generates the first subset of labelled datapoints associated with the corresponding label of the first set of labelled datapoints.

At 324, a first training dataset generation operation is performed. In the first training dataset generation operation, the computer system 202 generates the training dataset 214 based on the first set of labelled datapoints and the first subset of labelled datapoints. The computer system 202 combines the first set of labelled datapoints and the first subset of labelled datapoints to generate the training dataset 214. By way of example, and not by limitation, the training dataset 214 includes, for example, “John: People, Peter: People, William: People, Kartik: People, Kane: People, Sam: People, Edwards: People, Rahul: People, Henry: People, Smith: People, Robert: People, Lisa: People, Parth: People, Jason: People, Emily: People”. Similarly, the training dataset 214 may further include one or more labelled datapoints of each of the first subset of the labelled datapoints, each of which is generated based on the corresponding labelled datapoints of the first set of labelled datapoints.

In an embodiment of the disclosure, the computer system 202 determines a second quality score associated with the first subset of labelled datapoints. As discussed earlier, the computer system 202 determines the second quality score associated with the first subset of labelled datapoints based on the application of the set of filters on the first subset of labelled datapoints. In an embodiment of the disclosure, the computer system 202 similarly determines the second quality score based on the application of the set of rule-based filters and the set of policy-based filters on the first subset of labelled datapoints.

In an embodiment of the disclosure, the second quality score corresponds to one of a confidence score associated with the first subset of labelled datapoints or a perplexity score associated with the first subset of labelled datapoints. The confidence score associated with the first subset of labelled datapoints is a numerical value that indicates the first ML model's level of certainty in its generated response. The perplexity score associated with the first subset of labelled datapoints is a performance metric that is used to determine the first ML model's level of certainty in generating a sequence of words in the generated response. Mathematically, the perplexity score is the exponentiated average negative log-likelihood of the sequence of words in the generated response.

At 326, a second comparison operation is performed. In the second comparison operation, the computer system 202 compares the second quality score with a second threshold quality score. In an embodiment of the disclosure, the computer system 202 determines whether the second quality score is greater than or equal to the second threshold quality score to ensure that the quality of the generated training dataset 214, in the end, is high enough (greater than or equal to the threshold quality score), which is needed to train the second ML model 208 for performing zero-shot classification under latency and resource-constraints. In an embodiment of the disclosure, the computer system 202 determines whether the second confidence score associated with the first subset of labelled datapoints is greater than or equal to the second threshold confidence score. In an embodiment of the disclosure, the computer system 202 determines whether the second perplexity score associated with the first subset of labelled datapoints is less than or equal to the second threshold perplexity score. The control of operations shifts to 334 based on the determination that the second confidence score is greater than or equal to the second threshold confidence score. In an alternate embodiment of the disclosure, the control of operations shifts to 334 based on the determination that the second perplexity score is less than or equal to the second threshold perplexity score.

In the second comparison operation, the computer system 202 further compares a first count of labelled datapoints in the training dataset 214 with a count threshold. In an embodiment of the disclosure, the computer system 202 determines the first count of labelled datapoints being greater than or equal to the count threshold. The control of operations further shifts to 334 based on the determination that the second confidence score is greater than or equal to the second threshold confidence score, or if the second perplexity score is less than or equal to the second threshold perplexity score, or the first count of labelled datapoints in the training dataset 214 is greater than the count threshold. Otherwise, the control of operations shifts to 328.

At 328, a second prompt generation operation is performed. In the second prompt generation operation, the computer system 202 generates a second prompt associated with the second label of the plurality of labels. In an embodiment of the disclosure, the computer system 202 generates the second prompt based on the determination that the second quality score is less than the second threshold quality score or the determination that the first count is less than the count threshold. In an embodiment of the disclosure, the computer system 202 generates the second prompt based on the determination that the second confidence score is less than the second threshold confidence score. In an alternate embodiment of the disclosure, the computer system 202 generates the second prompt based on the determination that the second perplexity score is greater than the second threshold perplexity score. By way of example, and not by limitation, the computer system 202 generates the second prompt associated with the second label “Places” as “generate a numbered list containing names of 5 places”.

At 330, a fourth ML model application operation is performed. In the fourth ML model application operation, the computer system 202 applies the first ML model 206 to the second prompt. The first ML model 206 analyzes the second prompt corresponding to the second label of the plurality of labels. The first ML model 206 further identifies patterns and relationships in the second prompt associated with the second label of the plurality of labels based on its training data to generate a response to the second prompt. By way of example, and not by limitation, the first ML model 206 generates a first numbered list “1. USA, 2. India, 3. China, 4. Russia, 5. Japan”.

At 332, a second set of labelled datapoints generation operation is performed. In the second set of labelled datapoints generation operation, the computer system 202 generates a second set of labelled datapoints based on the application of the first ML model 206 to the second prompt. The computer system 202 analyzes the response of the first ML model 206 based on the second prompt associated with the second label of the plurality of labels to generate the second set of labelled datapoints. The second set of labelled datapoints includes at least one labelled datapoint associated with the second label of the plurality of labels. In an embodiment of the disclosure, the second set of labelled datapoints includes, for example, but is not limited to, “USA: Place, India: Place, China: Place, Russia: Place, Japan: Place”.

As discussed earlier, the computer system 202 similarly applies the set of filters (the set of rule-based filters and the set of policy-based filters) on the generated second set of labelled datapoints to check for successful data generation and to determine that the quality score associated with the generated second set of labelled datapoints is greater than or equal to a third threshold quality score, which is needed to generate a second subset of labelled datapoints and to ensure that the quality of the generated training dataset 214 in the end is greater than or equal to the third threshold quality score that is needed to train the second ML model 208 for performing zero-shot classification under latency and resource constraints. For example, the computer system 202 trains the second ML model 208 on the generated training dataset 214 having a quality score greater than or equal to the third threshold quality score, which enables the trained second ML model 208 to perform zero-shot classification in computing environments associated with one or more edge computing systems without a need for high-power CPUs and high-power GPUs.

At 334, a second sub-prompt generation operation is performed. In the second sub-prompt generation operation, the computer system 202 generates the second sub-prompt for the first ML model 206. The second sub-prompt is different from the second prompt. The second sub-prompt is associated with at least the one labelled datapoint in the second set of labelled datapoints. In an embodiment of the disclosure, the computer system 202 generates the second sub-prompt based on the determination that the confidence score associated with the second set of labelled datapoints is greater than or equal to the third threshold confidence quality score. In an alternate embodiment of the disclosure, the computer system 202 generates the second sub-prompt based on the determination that the perplexity score associated with the second set of labelled datapoints is less than or equal to the third threshold perplexity score. By way of example, and not by limitation, the computer system 202 generates the second sub-prompt for the labelled datapoint “USA” as “generate a numbered list of 5 states in USA”.

Similarly, the computer system 202 further generates the second sub-prompt in a hierarchical manner for each labelled datapoint of the second set of labelled datapoints starting from the datapoint “India” and excluding the datapoint “USA”. By way of example, and not by limitation, the computer system 202 generates the second sub-prompt that corresponds to the labelled datapoint “India”, for example, as “generate a numbered list of 5 states in India”.

At 336, a fifth ML model application operation is performed. In the fifth ML model application operation, the computer system 202 applies the first ML model 206 to the second sub-prompt. The first ML model 206 further identifies patterns and relationships in the second sub-prompt based on its training data to generate a response to the second sub-prompt. By way of example, and not by limitation, the first ML model 206 generates the numbered list associated with “USA” as “1. California is a state of the USA, 2. Florida is a state of USA, 3. New York is a state of USA, 4. Texas is a state of USA, 5. Georgia is a state of USA”.

Similarly, the first ML model 206 generates a numbered list based on the second sub-prompt associated with the corresponding labelled datapoint in the second set of labelled datapoint. By way of example, and not by limitation, the numbered list corresponding to India may be, for example, “1. Gujarat is a state of India, 2. Maharashtra is a state of India, 3. Karnataka is a state of India, 4. Madhya Pradesh is a state of India, 5. Uttar Pradesh is a state of India”.

At 338, a second subset of labelled datapoints generation operation is performed. In the second subset of labelled datapoints generation operation, the computer system 202 generates a second subset of labelled datapoints based on the application of the first ML model 206 to the second sub-prompt. The second subset of labelled datapoints is different from the second set of labelled datapoints. The computer system 202 analyzes the response of the first ML model 206 based on the second sub-prompt associated with at least the one labelled datapoint of the second set of labelled datapoints to generate the second subset of labelled datapoints. By way of example, and not by limitation, the second subset of labelled datapoints corresponding to “John” includes, for example, “California: Place, Florida: Place, New York: Place, Texas: Place, Georgia: Place”.

Similarly, the computer system 202 generates the second subset of labelled datapoints corresponding to each labelled datapoints from the second set of labelled datapoints in a hierarchical manner. By way of example, and not by limitation, the second subset of labelled datapoints corresponding to “India” includes, for example, “Gujarat: Place, Maharashtra: Place, Karnataka: Place, Madhya Pradesh: Place, Uttar Pradesh: Place”. In this manner, the computer system 202 hierarchically generates the second subset of labelled datapoints associated with the corresponding label of the second set of labelled datapoints.

At 340, a second training dataset generation operation is performed. In the second training dataset generation operation, the computer system 202 generates the training dataset 214 based on the first set of labelled datapoints, the first subset of labelled datapoints, the second set of labelled datapoints and the second subset of labelled datapoints. In an embodiment of the disclosure, the training dataset 214 includes the first set of labelled datapoints, the first subset of labelled datapoints, the second set of labelled datapoints and the second subset of labelled datapoints.

By way of example, and not by limitation, the training dataset 214 includes, for example, “John: People, Peter: People, William: People, Kartik: People, Kane: People, Sam: People, Edwards: People, Rahul: People, Henry: People, Smith: People, Robert: People, Lisa: People, Parth: People, Jason: People, Emily: People, USA: Place, India: Place, China: Place, Russia: Place, Japan: Place, California: Place, Florida: Place, New York: Place, Texas: Place, Georgia: Place, Gujarat: Place, Maharashtra: Place, Karnataka: Place, Madhya Pradesh: Place, Uttar Pradesh: Place”.

Similarly, the training dataset 214 may further include one or more labelled datapoints of each of the first subset of the labelled datapoints and each of the second subset of labelled datapoints, which are generated based on the corresponding labelled datapoints of the first set of labelled datapoints and the corresponding labelled datapoints of the second set of labelled datapoints respectively.

In an embodiment of the disclosure, the computer system 202 generates the training dataset 214 that includes the first set of labelled datapoints, the first subset of labelled datapoints, the second set of labelled datapoints and the second subset of labelled datapoints to ensure that a second count of labelled datapoints in the training dataset 214 is greater than or equal to the count threshold. In this manner, the computer system 202 further ensures that a third quality score associated with the training dataset 214 that includes the first set of labelled datapoints, the first subset of labelled datapoints, the second set of labelled datapoints and the second subset of labelled datapoints is greater than the third threshold quality score, which is needed to train the second ML model 208 for performing zero-shot classification under latency and resource constraints. For example, the computer system 202 trains the second ML model 208 on the generated high-quality training dataset 214 which enables the trained second ML model 208 to perform zero-shot classification at applications such as risk classification for health assistant, classification involving proprietary data, and topic classification without any delays due to latency constraints.

At 342, a third comparison operation is performed. In the third comparison operation, the computer system 202 compares the second count of labelled datapoints in the training dataset 214 with the count threshold. In an embodiment of the disclosure, the computer system 202 further determines that the second count of labelled datapoints in the training dataset 214 that includes the first set of labelled datapoints, the first subset of labelled datapoints, the second set of labelled datapoints and the second subset of labelled datapoints is greater than the count threshold. The control of operations shifts to 344 based on the determination that the second count of labelled datapoints in the training dataset 214 is greater than the count threshold.

In the third comparison operation, the computer system 202 further compares the third quality score associated with the training dataset 214 which includes the first set of labelled datapoints, the first subset of labelled datapoints, the second set of labelled datapoints and the second subset of labelled datapoints with the second quality score associated with the training dataset 214 that includes the first set of labelled datapoints and the first subset of labelled datapoints. In an embodiment of the disclosure, the computer system 202 determines that the third quality score is just less than the second quality score. In an embodiment of the disclosure, the computer system 202 determines that the third confidence score is just less than the second confidence score. In an alternate embodiment of the disclosure, the computer system 202 further determines that the third perplexity score associated with the training dataset 214 that includes the first set of labelled datapoints, the second set of labelled datapoints, the first subset of labelled datapoints and second subset of labelled datapoints is just greater than the second perplexity score associated with the training dataset 214 that includes the first set of labelled datapoints and the second set of labelled datapoints.

In an exemplary scenario, the training dataset 214 generated based on increasing the labelled datapoints may include various duplicate labelled datapoints and various incorrectly labelled datapoints, which may reduce the quality of the generated training dataset 214. This may lead to a condition when the third quality score becomes just less than the second quality score. In such a scenario, the computer system 202 applies an early stopping condition of the process, in which the computer system 202 determines whether the third quality score is just less than the second quality score (say within a threshold value of the second quality score). In an embodiment of the disclosure, the computer system 202 determines that the third confidence score is just less than the second confidence score. In an alternate embodiment of the disclosure, the computer system 202 determines that the third perplexity score is just greater than the second threshold perplexity score (since the lesser the perplexity score, the better the quality score). The control of operations shifts to 344 based on the determination that the second count is greater than the count threshold, the determination that the third confidence score is just less than the second confidence score, or the determination that the third perplexity score is just greater than the second perplexity score. Otherwise, the control of operations shifts back to 328 in which a next prompt associated with a next label of the plurality of labels is generated as discussed below.

In an embodiment of the disclosure, the computer system 202 iteratively generates the next prompt associated with the corresponding next label (in this case, the third label “organizations”) of the plurality of labels and similarly applies the first ML model 206 on the next prompt to similarly generate the next set of labelled datapoints (and the next subset of labelled datapoints) to generate the training dataset 214 until the count of the labelled datapoints in the training dataset 214 is greater than the count threshold or a next confidence score is just less than a previous confidence score (early stopping) or a next perplexity score is just greater than a previous perplexity score. In this manner, the computer system 202 ensures that the quality of the generated training dataset 214 is high enough (greater than or equal to the threshold quality score), which is needed to train the second ML model 208 for performing zero-shot classification under latency and resource constraints. For example, the computer system 202 trains the second ML model 208 on the generated high-quality training dataset 214 which enables the trained second ML model 208 to perform zero-shot classification at applications such as risk classification for health assistant, classification involving proprietary data, and topic classification without any delays due to latency constraints.

At 344, a training dataset output operation is performed. In the training dataset output operation, the computer system 202 outputs the training dataset 214. In an embodiment of the disclosure, the computer system 202 outputs the training dataset 214 based on the determination that the second quality score associated with the training dataset 214 is greater than or equal to the second threshold quality score (in the case of confidence score). In an alternate embodiment of the disclosure, the computer system 202 outputs the training dataset 214 based on the determination 0098 US that the first count is greater than or equal to the count threshold. In an alternate embodiment of the disclosure, the computer system 202 outputs the training dataset 214 based on the determination that the second count is greater than or equal to the count threshold.

In an embodiment of the disclosure, the computer system 202 outputs the training dataset 214 based on the determination that the third quality score is just less than the second quality score (early stopping). In an embodiment of the disclosure, the computer system 202 outputs the training dataset 214 after performing quality checks at various levels of generation that ensure that the quality of the training dataset 214 is high enough (greater than or equal to the threshold quality score) which is needed to train the second ML model 208 for performing zero-shot classification under latency and resource-constraints.

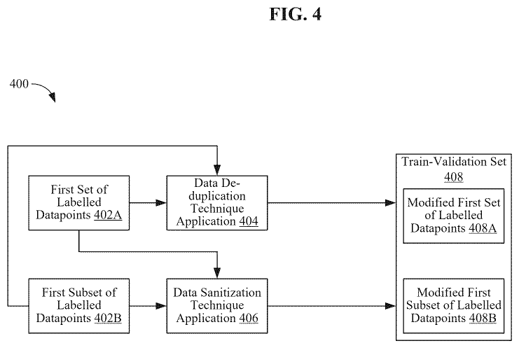

FIG. 4 illustrates exemplary operations for application of one or more data processing techniques for generation of synthetic datasets using machine learning (ML) models for zero-shot classification, in accordance with an embodiment of the disclosure. FIG. 4 is explained in conjunction with elements from FIG. 1, FIG. 2, and FIG. 3. With reference to FIG. 4, there is shown the block diagram 400 that includes a first set of labelled datapoints 402A, and a first subset of labelled datapoints 402B. The block diagram 400 further illustrates exemplary operations from 404 to 406, as described herein. With reference to FIG. 4, there is further shown a train-validation set 408. The train-validation set 408 includes a modified first set of labelled datapoints 408A and a modified first subset of labelled datapoints 408B. The exemplary operations illustrated in the block diagram 400 start at 404 and are performed by any computing system, apparatus, or device, such as by the computer 102 of FIG. 1 or by the computer system 202 of FIG. 2. Although illustrated with discrete blocks, the exemplary operations associated with one or more blocks of the block diagram 300 can be divided into additional blocks, combined into fewer blocks, or eliminated, depending on the implementation.

As discussed earlier, the first set of labelled datapoints 402A includes at least the one labelled datapoint associated with the first label of the plurality of labels. By way of example, and not by limitation, the first set of labelled datapoints includes one or more labelled datapoints associated with “People”, for example, but not limited to “John: People, John: People, Peter: People, William: People, Kartik: People, Kane: People”. Similarly, the first subset of labelled datapoints 402B includes one or more labelled datapoints associated with at least the one labelled datapoint of the first set of labels. By way of example, and not by limitation, the first subset of labelled datapoints includes one or more labelled datapoints associated with, for example, “John” as “Sam: People, Ed-wards: People, Rahul: People, Henry: People, Smith: People”. In an embodiment of the disclosure, the computer system 202 applies one or more data processing techniques on the first set of labelled datapoints 402A and the first subset of labelled datapoints 402B. The one or more data processing techniques include at least a data-duplication technique and a data sanitization technique.

At 404, a data de-duplication technique application operation is performed. In the data-deduplication technique application operation, the computer system 202 applies the data-deduplication technique on the first set of labelled datapoints 402A and the first subset of labelled datapoints 402B, respectively. In an embodiment of the disclosure, the computer system 202 applies the data-deduplication technique on the first set of labelled datapoints 402A and the first subset of labelled datapoints 402B to remove one or more redundant labelled datapoints and generate the modified first set of labelled datapoints 408A and the modified first subset of labelled datapoints 408B respectively. The computer system 202 removes the one or more labelled datapoints which are redundant, or which have multiple occurrences within the first set of labelled datapoints 402A and the first subset of labelled datapoints 402B based on the application of the data-deduplication technique on the first set of labelled datapoints 402A and the first subset of labelled datapoints 402B.

By way of example, and not by limitation, if any of the first set of labelled datapoints or the first subset of datapoints include one or more redundant labelled datapoints, then the computer system 202 removes them based on the application of the data-deduplication technique. For example, the first set of labelled datapoints “John: People, John: People, Peter: People, William: People, Kartik: People, Kane: People” include a redundant labelled datapoint “John: People”. The computer system 202 removes the multiple occurrences of “John: People” in such a scenario.

In an embodiment of the disclosure, the computer system 202 may utilize one or more predefined open-source libraries to remove the one or more redundant labelled datapoints. In an embodiment of the disclosure, the computer system 202 may perform hash-based exact deduplication to remove one or more redundant labelled datapoints. In the hash-based exact deduplication, the computer system 202 selects a predefined hash algorithm to generate hash values for the corresponding labelled datapoint in the first set of labelled datapoints and the corresponding labelled datapoint in the first subset of labelled datapoint, respectively. The computer system 202 further stores the hash values in a dictionary. As the computer system 202 generates the next hash values for the corresponding datapoints, the computer system 202 checks if the hash value already exists in the dictionary. If the hash value already exists, then the computer system 202 may identify the corresponding labelled datapoint as a duplicate datapoint that may be redundant and further removes the corresponding datapoint. Details about the hash-based exact deduplication are known in the art and therefore have been omitted for the sake of brevity.

In an alternate embodiment of the disclosure, the computer system 202 applies a bloom-filter-based deduplication to remove the one or more redundant labelled datapoints. In the bloom-filter-based deduplication, the computer system 202 initializes a bloom filter with a size-value and a number of hash functions. The size value and the number of hash functions depend on the count of labelled datapoints in the first set of labelled datapoints and the first subset of labelled datapoints. The computer system 202 then calculates hash values for each labelled datapoint in the first set of labelled datapoints and each labelled datapoint in the first subset of labelled datapoints and sets the corresponding bits in the bloom filter. The computer system 202 then calculates the next hash values for the corresponding datapoints, and checks if the bits in the bloom filter are already set corresponding to the corresponding labelled dataset. If the bits are already set, then the computer system 202 may identify the corresponding labelled datapoint as redundant and remove the corresponding datapoint. Details about the bloom-filter-based deduplication are known in the art and therefore have been omitted for the sake of brevity.

In an alternate embodiment of the disclosure, the computer system 202 may apply a fuzzy deduplication using locality-sensitive hashing to remove the one or more redundant labelled datapoints. In the fuzzy deduplication, the computer system 202 generates hash values for each labelled datapoint in the first set of labelled datapoints and each labelled datapoint in the first subset of labelled datapoints. The computer system 202 further calculates a similarity score of the various labelled datapoints. If the similarity score for a corresponding labelled datapoint is greater than a threshold similarity score, then the computer system 202 may identify the corresponding labelled datapoint as redundant and remove the corresponding datapoint.

At 406, a data sanitization technique application operation is performed. In the data sanitization technique application operation, the computer system 202 applies the data sanitization technique on the first set of labelled datapoints 402A and the first subset of labelled datapoints 402B, respectively. In an embodiment of the disclosure, the computer system 202 applies the data sanitization technique on the first set of labelled datapoints 402A and the first subset of labelled datapoints 402B, respectively, to generate the modified first set of labelled datapoints 408A and the modified first subset of labelled datapoints 408B, respectively.

By way of example, and not by limitation, the computer system 202 removes one or more labelled datapoints based on the application of one or more data sanitization techniques. The computer system 202 removes the specific labelled datapoints in which the length of the characters in the input data is greater than a predefined threshold length of characters. For example, if the predefined threshold length of characters is 50 and say the first set of labelled datapoints includes a specific labelled datapoint “Charles is an athlete who loves to play cricket and badminton. Charles is very good at playing cricket but not as great at playing badminton. Charles needs to give more time to his badminton practice in order to become as good in badminton as he is in cricket: People” in which the length of characters is greater than the predefined threshold length of characters (50), then the computer system 202 removes the specific labelled datapoint.

In an embodiment of the disclosure, the computer system 202 removes the one or more punctuation marks, one or more separators (for example “−”, “,”) and numbers from the second set of labelled datapoints. For example, the first subset of labelled datapoints includes a specific labelled datapoint “Ed-wards: People”, then the computer system 202 removes the one or more separators from the specific labelled datapoint. The labelled datapoint will be modified as “Edwards: People”.

In an embodiment of the disclosure, the computer system 202 similarly applies the one or more data processing techniques on each of the second set of labelled datapoints and the second subset of labelled datapoints to generate the modified second set of labelled datapoints and the modified second subset of labelled datapoints with no redundant labelled datapoints to ensure that the quality of the generated train-validation set 408 is high enough (greater than the threshold quality score) to train the second ML model 208 (the lightweight classifier) for performing zero-shot classification under latency and resource constraints. For example, the computer system 202 trains the second ML model 208 based on the generated train-validation set 408. The trained second ML model 208 can perform zero-shot classification in computing environments associated with one or more edge computing systems without a need for high-power CPUs and high-power GPUs.

In an embodiment of the disclosure, the computer system 202 generates the train-validation set 408 based on the application of the one or more data processing techniques on the first set of labelled datapoints 402A and the first subset of labelled datapoints 402B respectively. The train-validation set 408 includes the modified first set of labelled datapoints 408A and the modified first subset of labelled datapoints 408B with no redundant labelled datapoints. The second quality score associated with the generated train-validation set 408 is greater than the second threshold quality score, which is used to ensure that the quality of the train-validation set 408 is high enough (greater than or equal to the threshold quality score) to train the second ML model 208 (the lightweight classifier) for performing zero-shot classification under latency and resource constraints. For example, the trained second ML model 208 can efficiently perform zero-shot classification in computing environments associated with one or more edge computing systems without a need for high-power CPUs and high-power GPUs.

Similarly, the computer system 202 generates a modified second set of labelled datapoints and the modified second subset of labelled datapoints is associated with the second prompt. This may be done iteratively for each label of the plurality of labels to generate corresponding sets and subsets of labelled datapoints.

FIG. 5 is a diagram that illustrates training of a machine learning (ML) model for performing zero-shot classification under latency and resource constraints, in accordance with an embodiment of the disclosure. As shown, there is a training portion above line 500 and an implementation portion below line 500. In the training portion above line 500, the computer system 202 generates the train-validation set 408 for the training 502 of the second ML model 208. As discussed earlier, the train-validation set 408 includes at least the modified first set of labelled datapoints 408A and the modified first subset of labelled datapoints 408B. In an embodiment, the train-validation set 408 includes at least the modified second set of labelled datapoints and the modified second subset of labelled datapoints.

In an embodiment of the disclosure, a portion of the train-validation set 408 may be shown in Table 1 below:

TABLE 1
Train-Validation Set

| Input data | Output Data |
|---|---|
| John | People |
| Peter | People |
| India | Place |
| XYZ global empowerment | Organization |
| Florida | Place |
| Sam | People |
| ABC Corporation | Organization |
| Johannesburg | Place |
| Delhi | Place |
| Robert | People |
| Emily | People |
| Denmark | Place |
| Smith | People |
| Romania | Place |
| PQR energy solutions | Organization |

In an embodiment of the disclosure, the train-validation set 408 includes input data and corresponding output data for training the second ML model 208. The input data is associated with the second input and each corresponding output data is associated with at least one label of the plurality of labels.

At 504, a training dataset determination operation is performed. In the training dataset determination operation, the computer system 202 partitions the modified first set of labelled datapoints and the modified first subset of labelled datapoints into the training dataset 214 and the validation dataset. In an embodiment of the disclosure, the computer system 202 partitions the modified first set of labelled datapoints and the modified first subset of labelled datapoints based on a threshold ratio. In an embodiment of the disclosure the threshold ratio is 4:1. By way of example, and not by limitation, if the modified first set of labelled datapoints and the modified first subset of labelled datapoints includes 15 labelled datapoints (as shown in the table above), then the training dataset 214 includes 12 labelled datapoints.

At 506, a validation dataset determination operation is performed. In the validation dataset determination operation, the computer system 202 partitions the modified first set of labelled datapoints and the modified first subset of labelled datapoints into the training dataset 214 and the validation dataset. In an embodiment of the disclosure, the computer system 202 partitions the modified first set of labelled datapoints and the modified first subset of labelled datapoints based on a threshold ratio. In an embodiment of the disclosure the threshold ratio is 4:1. By way of example, and not by limitation, in case the train-validation set 408 includes 15 labelled datapoints (as shown in the table above), then the validation dataset includes 3 labelled datapoints. The validation dataset similarly includes the set of input data and the set of corresponding output data. Each input data of the set of input data is associated with the second input and each corresponding output data is associated with at least one label of the plurality of labels.

At 508, a second ML model training operation is performed. In the second ML model training operation, the computer system 202 trains the second ML model 208 based on the training dataset 214. In an embodiment of the disclosure, the computer system 202 provides the second ML model 208 with the training dataset 214. The second ML model 208 then analyzes the set of input data and the set of corresponding data in the training dataset 214 to identify patterns and relationships between the set of input data and the set of corresponding output data. Specifically, the second ML model 208 determines a machine learning algorithm for classifying the second input into at least one label of the plurality of labels based on the identified patterns and relationships between the set of input data and the set of corresponding output data. The second ML model 208 further utilizes the machine learning algorithm for classifying the second input into at least one label of the plurality of labels.

In an embodiment of the disclosure, the training 502 of the second ML model corresponds to the tuning of one or more hyper-parameters associated with the second ML model based on the training dataset 214. In an embodiment of the disclosure, the computer system 202 adjusts the one or more hyperparameters (the weights and the regularization parameters) of the neural network corresponding to the second ML model 208 based on the identified patterns and the identified relationships between the set of input data and the set of corresponding output data in the training dataset 214 for performing zero-shot classification under latency and resource constraints.

In an embodiment of the disclosure, the computer system 202 adjusts the one or more hyper-parameters of each node of the neural network corresponding to the second ML model 208 based on whether the predicted output of the final layer for each input data of the set of input data (from the training dataset 214) matches the actual output in the corresponding output data of the set of corresponding output data. The computer system 202 calculates a loss function or a training error associated with the second ML model 208 based on whether the predicted output matches the actual output in the validation dataset or not. The computer system 202 further repeats the adjustment of one or more hyper-parameters until a minima of the loss function is achieved, or until the training error is minimized.

At 510, a second ML model validation operation is performed. In the second ML model validation operation, the computer system 202 validates the second ML model 208 based on the validation dataset. The second ML model 208 is trained on the training dataset 214. In an embodiment of the disclosure, the computer system 202 validates the values of each of the one or more hyper-parameters of the neural network corresponding to the second ML model 208 based on the validation dataset. In an embodiment of the disclosure, the computer system 202 determines a performance score for the second ML model 208 based on the validation. The performance score is associated with one or more performance metrics of the second ML model 208. In an embodiment of the disclosure, the one or more performance metrics correspond to at least one of an accuracy of the second ML model 208, a precision of the second ML model 208, a recall of the second ML model 208, or a confusion matrix of the second ML model 208.

In an embodiment of the disclosure, the computer system 202 determines the accuracy of the second ML model based on calculating the true positive (TP) classifications (for example when the second ML model 208 classifies a People second input as People), true negative (TN) classifications (for example when the second ML model 208 classifies a non-People second input as non-People), false positive (FP) classifications (for example when the second ML model 208 classifies a non-People second input as People) and false negative (FN) classifications (for example when the second ML model 208 classifies a People classification as non-People). The computer system 202 determines the confusion matrix of the second ML model 208 based on each of the TP classifications, TN classifications, FP classifications and FN classifications. The computer system 202 further determines the accuracy using the formula:

$$Accuracy = \frac{TP + TN}{TP + TN + FP + FN} \qquad ( 1 )$$

In an embodiment of the disclosure, the computer system 202 determines the precision of the second ML model 208 using the formula:

$$Precision = \frac{TP}{TP + FP} \qquad ( 2 )$$

In an embodiment of the disclosure, the computer system 202 determines the recall of the second ML model 208 using the formula:

$$Recall = \frac{TP}{TP + FN} \qquad ( 3 )$$

At 512, a second ML model output operation is performed. In the second ML model output operation, the computer system 202 outputs the second ML model 208 for performing zero-shot classification. Specifically, the computer system 202 deploys the trained second ML model 208 for performing zero-shot classification. In an alternate embodiment of the disclosure, the computer system 202 stores the trained second ML model 208 for performing zero-shot classification. In an embodiment of the disclosure, the computer system 202 determines the one or more performance metrics of the second ML model 208 to ensure that the performance score of the outputted second ML model 208 is greater than a threshold performance score, which is needed for performing the zero-shot classification under latency and resource constraints. For example, the outputted second ML model 208 can efficiently perform zero-shot classification in computing environments associated with one or more edge computing systems without a need for high-power CPUs and high-power GPUs. As an alternate example, the outputted second ML model 208 can perform zero-shot classifications for applications such as risk classification for health assistants, classification involving proprietary data, and topic classification without any delays due to latency constraints.

In the implementation portion below line 500, at 514 a second input reception operation is performed. In the second input reception operation, the computer system 202 receives the second input from the user device 204 associated with the user 216. The second ML model 208 is trained to classify the second input into at least one label of the plurality of labels. The second input includes the data which is to be classified into at least one label of the plurality of labels. The second input may be in any of the formats such as text data, image data, video data, or the like. By way of example, and not by limitation, the computer system 202 receives the second input for classification into at least one label of the plurality of labels as “Amazon Rainforest”.

At 516, a second ML model application operation is performed. In the second ML model application operation, the computer system 202 applies the second ML model 208 on the received second input. The second ML model 208 is trained to classify the second input into at least one label of the plurality of labels. In an embodiment of the disclosure, the second ML model 208 analyzes the second input and identifies the patterns and relationships based on the training dataset 214 to classify the second input into at least one label of the plurality of labels. In an embodiment of the disclosure, the computer system 202 classifies the second input based on the application of the second ML model 208 on the second input.

By way of example, and not by limitation, the computer system 202 applies the trained second ML model 208 to classify the second input “Amazon Rainforest” into at least one label of the plurality of labels including the first label labelled as “People”, the second label labelled as “Places”, and the third label labelled as “Organizations”. For example, the second ML model 208 may classify the second input “Amazon Rainforest” as a “Place”.

At 518, a result rendering operation is performed. In the result rendering operation, the computer system 202 renders at least one label of the plurality of labels. In an embodiment of the disclosure, the computer system 202 renders at least one label of the plurality of labels on the user device 204. By way of example, and not by limitation, the computer system 202 renders at least one label of the plurality of labels as “Place”.

FIG. 6 is a diagram that illustrates an exemplary knowledge base, in accordance with an embodiment of the disclosure. FIG. 6 is explained in conjunction with elements from FIG. 1, FIG. 2, FIG. 3, FIG. 4, and FIG. 5. With reference to FIG. 6, there is shown an exemplary knowledge base 600. The exemplary knowledge base 600 includes an XYZ ontology tree 602. The XYZ ontology tree 602 includes a first branch of people 604, a second branch of place 606, and a third branch of organization 608. The first branch of people 604 further includes a first sub-branch of athlete 610, a second sub-branch of politician 612, and a third sub-branch of scientist 614. The first sub-branch of athlete 610 further includes a next branch of boxer 616, a next sub-branch of chess player 618, and a next sub-branch of soccer player 620.

In an embodiment of the disclosure, the computer system 202 generates the first prompt and the first sub-prompt based on the traversal of the ontology trees and knowledge graphs. The computer system 202 may generate the first prompt based on the traversal of the XYZ ontology tree 602. The computer system 202 may utilize a traversal algorithm for traversing the XYZ ontology tree 602. In an embodiment of the disclosure, the computer system 202 generates the first prompt corresponding to the first branch of the people 604 as “generate a numbered list containing names of 5 different people” based on the traversal of the XYZ ontology tree 602.

Similarly, the computer system 202 generates the second prompt corresponding to the second branch of place 606 as “generate a numbered list containing names of 5 different places” based on the traversal of the XYZ ontology tree 602. Similarly, the computer system 202 generates the second prompt corresponding to the third branch of organization 608 as “generate a numbered list containing names of 5 different organizations” based on the traversal of the XYZ ontology tree 602. By way of example, and not by limitation, the traversal algorithm may be one of, a breadth-first search algorithm, a depth-first search algorithm, an A* algorithm, an AO* algorithm or the like.

In an embodiment of the disclosure, the computer system 202 further utilizes the traversal algorithm to traverse the XYZ ontology tree 602. The computer system 202 generates the first sub-prompt corresponding to the first sub-branch of athlete 610 as “generate a numbered list containing names of 5 different athletes”. Similarly, the computer system 202 generates the first sub-prompt corresponding to the second sub-branch of politician 612 as “generate a numbered list containing names of 5 different politicians”. Similarly, the computer system 202 generates the first sub-prompt corresponding to the third sub-branch of scientist 614 as “generate a numbered list containing names of 5 different scientists”.

In an embodiment of the disclosure, the computer system 202 further utilizes the ontology trees to generate one or more hierarchical prompts based on traversing the XYZ ontology tree 602. In an embodiment of the disclosure, the computer system 202 further traverses the first sub-branch of athletes 610 to generate the next sub-prompts associated with the next sub-branch of boxer 616, the next sub-branch of chess player 618 and the next sub-branch of soccer player 620. In an embodiment of the disclosure, the computer system 202 similarly traverses the second branch of places and the third branch of organizations to generate the next sub-prompts associated with specific places and specific organizations, respectively.

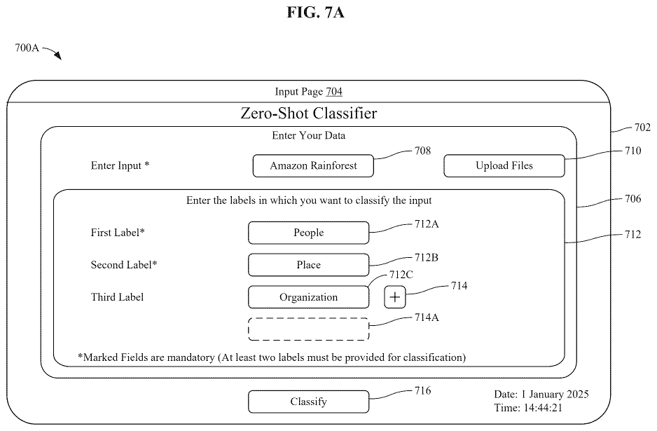

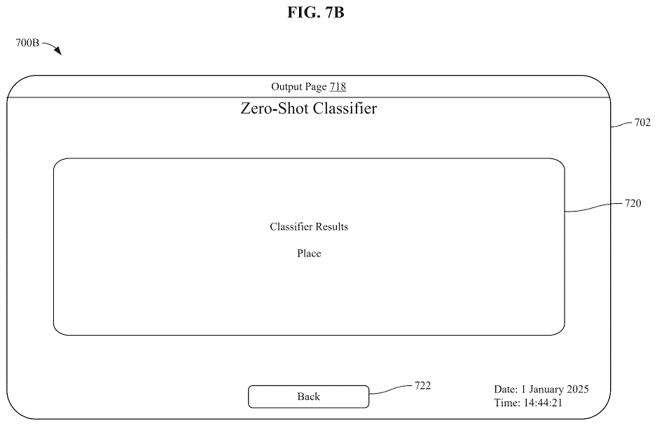

FIG. 7A is a diagram that illustrates an exemplary first user interface for zero-shot classification under latency and resource constraints, in accordance with an embodiment of the disclosure. FIG. 7A is explained in conjunction with elements from FIG. 1, FIG. 2, FIG. 3, FIG. 4, FIG. 5 and FIG. 6. With reference to FIG. 7A, there is shown an exemplary diagram 700A that includes a user device 702 and an exemplary input page 704. The exemplary input page 704 includes a first user interface (UI) element 706, a second UI element 708, and a third UI element 710. The exemplary input page 704 further includes a fourth UI element 712, a fifth UI element 712A, a sixth UI element 712B, and a seventh UI element 712C. The exemplary input page 704 further includes an eighth UI element 714, a ninth UI element 714A and a tenth UI element 716. The user device 702 is an exemplary embodiment of the user device 204 of FIG. 2.

With reference to FIG. 7A, the computer system 202 receives the second input and the plurality of labels from the user device 702. The user device 702 includes a display unit (a user interface) that renders the input page 704 to the user 216. The computer system 202 renders the input page 704 on the user interface (UI) of the user device 702. The input page 704 corresponds to a web page or online form that is designed to collect information from entities who wish to classify any form of data be it text, image, video or the like into the plurality of labels. In an embodiment of the disclosure, the input page 704 is used to gather relevant details from the entities for classifying the second input into at least one label of the plurality of labels.

The first UI element 706 corresponds to a textbox which includes a message for user 216, for example, “Enter Your Data”. The first UI element 706 further includes the second UI element 708, the third UI element 710, and the fourth UI element 712. The second UI element 708 corresponds to a textbox labelled “Enter input”. The second UI element 708 is used to obtain the second input. For example, the computer system 202 obtains the second input as “Amazon Rainforest”. In an embodiment of the disclosure, the second UI element 708 is a mandatory input parameter that needs to be provided for the classification. By way of example, and not by limitation, the computer system 202 obtains the second input as “Peter”. By way of example, and not by limitation, the computer system 202 obtains the second input as “Eifel Tower”. By way of example, and not by limitation, the computer system 202 obtains the second input as “ABC corporation”.

The third UI element 710 corresponds to a button and is labelled as “Upload Files”. Upon selecting the third UI element 710, the user 216 is asked to provide the user input in the form of a file in any format such as an image file, a video file or the like. Then, the computer system 202 obtains the user input upon providing the file. The fourth UI element 712 corresponds to a textbox and is labelled as “Enter the labels in which you want to classify the input”. The fourth UI element 712 further includes the fifth UI element 712A, the sixth UI element 712B, the seventh UI element 712C and the eighth UI element 714.

The fifth UI element 712A corresponds to a textbox labelled as “First label”. In an embodiment of the disclosure, the computer system 202 obtains the first label of the plurality of labels upon selecting the fifth UI element 712A. For example, the computer system 202 obtains the first label of the plurality of labels labelled as “People”. In an embodiment of the disclosure, the fifth UI element 712A is a mandatory input parameter that needs to be provided for the classification.

The sixth UI element 712B corresponds to a textbox labelled as “Second label”. In an embodiment of the disclosure, the computer system 202 obtains the second label of the plurality of labels upon selecting the sixth UI element 712B. For example, the computer system 202 obtains the second label of the plurality of labels labelled as “Place”. In an embodiment of the disclosure, the sixth UI element 712B is a mandatory second input parameter that needs to be provided for the classification.

The seventh UI element 712C corresponds to a textbox labelled as “Third label”. In an embodiment of the disclosure, the computer system 202 obtains the third label of the plurality of labels upon selecting the seventh UI element 712C. For example, the computer system 202 obtains the third label of the plurality of labels labelled as “Organization”.

The eighth UI element 714 corresponds to a button labelled with an icon “+”. Upon clicking the button corresponding to the eighth UI element, the computer system 202 renders the ninth UI element 714A on the user interface of the user device 702. The ninth UI element 714A corresponds to a drop-down list of textboxes that allows the user to second input one or more labels after providing the initial three labels of the plurality of labels. If the user 216 wishes to provide more than three labels, then the user 216 may provide them via the drop-down list of text boxes. The tenth UI element 716 corresponds to a button and is labeled as “Classify”. Upon selecting the tenth UI element 716, the computer system 202 receives the second input and further initiates the zero-shot classification.

FIG. 7B is a diagram that illustrates an exemplary second user interface for zero-shot classification under latency and resource constraints, in accordance with an embodiment of the disclosure. FIG. 7B is explained in conjunction with elements from FIG. 1, FIG. 2, FIG. 3, FIG. 4, FIG. 5, FIG. 6 and FIG. 7A. With reference to FIG. 7B, there is shown an exemplary diagram 700B that includes the user device 702 and an exemplary output page 718. The exemplary output page 718 includes an eleventh UI element 720 and a twelfth UI element 722. The user device 702 is an exemplary embodiment of the user device 204 of FIG. 2.

With reference to FIG. 7B, the computer system 202 renders the output page 718 on the display unit (or the user interface) of the user device 702 based on when the second ML model 208 classifies the second input. The computer system 202 renders at least one label of the plurality of labels on the output page 718 based on the classification. The output page 718 provides the information associated with the classification to the user 216.

The eleventh UI element 720 corresponds to a textbox that includes at least one label of the plurality of labels. By way of example, and not by limitation, the at least one label may be, for example, “Place” corresponding to the second input “Amazon Rainforest”. By way of example, and not by limitation, the at least one label may be, for example, “People” corresponding to the second input “Peter”. By way of example, and not by limitation, the at least one label may be, for example, “Place” corresponding to the second input “Eifel Tower”. By way of example, and not by limitation, the at least one label may be, for example, “Organization” corresponding to the second input “ABC corporation”. The twelfth UI element 722 corresponds to a button and is labelled as “Back”. In an embodiment of the disclosure, the computer system 202 renders the input page 704 on the user interface of the user device 702 based on when the user selects the twelfth UI element 722.

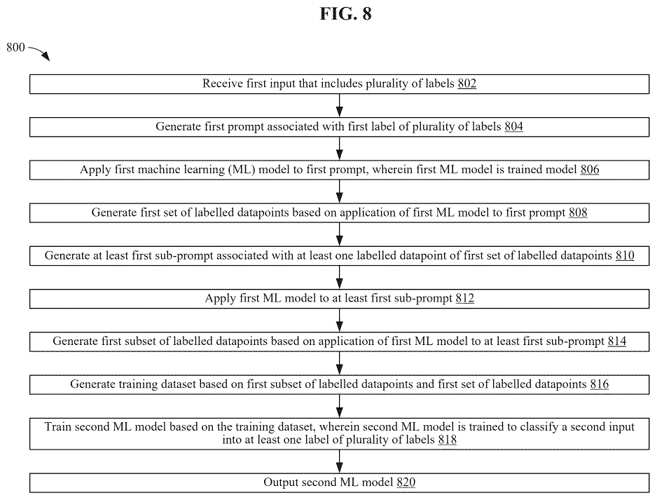

FIG. 8 is a diagram that illustrates a flowchart of an exemplary method for outputting a machine learning (ML) model for performing zero-shot classification under latency and resource constraints, in accordance with an embodiment of the disclosure. FIG. 8 is explained in conjunction with elements from FIG. 1, FIG. 2, FIG. 3, FIG. 4, FIG. 5, FIG. 6, FIG. 7A and FIG. 7B. With reference to FIG. 8, there is shown a flowchart 800. The operations of the exemplary method may be executed by any computing system, for example, by the computer 102 of FIG. 1 or the computer system 202 of FIG. 2. The operations of the flowchart 800 may start at 802.

At 802, the first input including the plurality of labels is received. In an embodiment of the disclosure, the computer system 202 receives the first input including the plurality of labels. Details about the first input reception operation are provided, for example, in FIG. 3.

At 804, the first prompt associated with the first label of the plurality of labels is generated. In an embodiment of the disclosure, the computer system 202 generates the first prompt associated with the first label of the plurality of labels. Details about the first prompt generation operation are provided, for example, in FIG. 3 and FIG. 6.

At 806, the first ML model 206 is applied to the first prompt. The first ML model 206 is the trained model. In an embodiment of the disclosure, the computer system 202 applies the first ML model 206 to the first prompt. The first ML model 206 is the trained model. Details about the first prompt application operation are provided, for example, in FIG. 3.

At 808, the first set of labelled datapoints is generated based on the application of the first ML model 206 to the first prompt. In an embodiment of the disclosure, the computer system 202 generates the first set of labelled datapoints based on the application of the first ML model 206 to the first prompt. Details about the first set of labelled datapoints generation operation are provided, for example, in FIG. 3.

At 810, at least the first sub-prompt associated with at least the one labelled datapoint of the first set of labelled datapoints is generated. In an embodiment of the disclosure, the computer system 202 generates at least the first sub-prompt associated with at least the one labelled datapoint of the first set of labelled datapoints. The first sub-prompt is different from the first prompt. Details about the first sub-prompt generation operation are provided, for example, in FIG. 3 and FIG. 6.

At 812, the first ML model 206 is applied to the at least first sub-prompt. In an embodiment of the disclosure, the computer system 202 applies the first ML model 206 to the at least first sub-prompt. Details about the first sub-prompt application operation are provided, for example, in FIG. 3.

At 814, the first subset of labelled datapoints is generated based on the application of the first ML model 206 to the first sub-prompt. In an embodiment of the disclosure, the computer system 202 generates the first subset of labelled datapoints based on the application of the first ML model 206 to the first sub-prompt. The first subset of labelled datapoints is different from the first set of labelled datapoints. Details about the first subset of labelled datapoints generation operation are provided, for example, in FIG. 3.

At 816, the training dataset 214 is generated based on the first set of labelled datapoints and the first subset of labelled datapoints. In an embodiment of the disclosure, the computer system 202 generates the training dataset 214 based on the first set of labelled datapoints and the first subset of labelled datapoints. Details about the training dataset generation operation are provided, for example, in FIG. 3.

At 818, the second ML model 208 is trained based on the training dataset 214. The second ML model 208 is trained to classify the second input into at least one label of the plurality of labels. In an embodiment of the disclosure, the computer system 202 trains the second ML model 208 based on the training dataset 214. The second ML model 208 is trained to classify the second input into at least one label of the plurality of labels. Details about the second ML model training operation are provided, for example, in FIG. 5.

At 820, the second ML model 208 is output. In an embodiment of the disclosure, the computer system 202 outputs the second ML model 208. Details about the second ML model output operation are provided, for example, in FIG. 5.

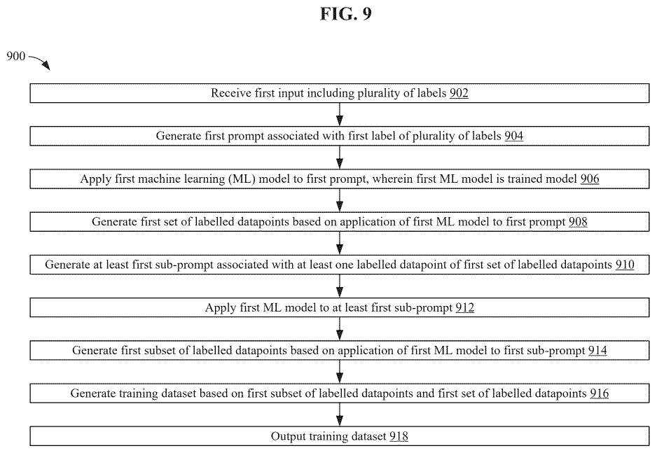

FIG. 9 is a diagram that illustrates a flowchart of an exemplary method for generation of synthetic datasets using machine learning (ML) models for zero-shot classification, in accordance with an embodiment of the disclosure. FIG. 9 is explained in conjunction with elements from FIG. 1, FIG. 2, FIG. 3, FIG. 4, FIG. 5, FIG. 6, FIG. 7A, FIG. 7B, and FIG. 8. With reference to FIG. 9, there is shown a flowchart 900. The operations of the exemplary method may be executed by any computing system, for example, by the computer 102 of FIG. 1 or the computer system 202 of FIG. 2. The operations of the flowchart 900 may start at 902.

At 902, the first input including the plurality of labels is received. In an embodiment of the disclosure, the computer system 202 receives the first input including the plurality of labels. Details about the first input reception operation are provided, for example, in FIG. 3.

At 904, the first prompt associated with the first label of the plurality of labels is generated. In an embodiment of the disclosure, the computer system 202 generates the first prompt associated with the first label of the plurality of labels. Details about the first prompt generation operation are provided, for example, in FIG. 3 and FIG. 6.

At 906, the first ML model 206 is applied to the first prompt. The first ML model 206 is the trained model. In an embodiment of the disclosure, the computer system 202 applies the first ML model 206 to the first prompt. The first ML model 206 is the trained model. Details about the first prompt application operation are provided, for example, in FIG. 3.

At 908, the first set of labelled datapoints is generated based on the application of the first ML model 206 to the first prompt. In an embodiment of the disclosure, the computer system 202 generates the first set of labelled datapoints based on the application of the first ML model 206 to the first prompt. Details about the first set of labelled datapoints generation operation are provided, for example, in FIG. 3.

At 910, the at least first sub-prompt associated with at least the one labelled datapoint of the first set of labelled datapoints is generated. In an embodiment of the disclosure, the computer system 202 generates the at least first sub-prompt associated with at least the one labelled datapoint of the first set of labelled datapoints. The first sub-prompt is different from the first prompt. Details about the first sub-prompt generation operation are provided, for example, in FIG. 3 and FIG. 6.

At 912, the first ML model 206 is applied to the at least first sub-prompt. In an embodiment of the disclosure, the computer system 202 applies the first ML model 206 to the at least first sub-prompt. Details about the first sub-prompt application operation are provided, for example, in FIG. 3.

At 914, the first subset of labelled datapoints is generated based on the application of the first ML model 206 to the at least first sub-prompt. In an embodiment of the disclosure, the computer system 202 generates the first subset of labelled datapoints based on the application of the first ML model 206 to the at least first sub-prompt. The first subset of labelled datapoints is different from the first set of labelled datapoints. Details about the first subset of labelled datapoints generation operation are provided, for example, in FIG. 3.

At 916, the training dataset 214 is generated based on the first set of labelled datapoints and the first subset of labelled datapoints. In an embodiment of the disclosure, the computer system 202 generates the training dataset 214 based on the first set of labelled datapoints and the first subset of labelled datapoints. Details about the training dataset generation operation are provided, for example, in FIG. 3.

At 918, the training dataset 214 is outputted. In an embodiment of the disclosure, the computer system 202 outputs the training dataset 214. Details about the training dataset output operation are provided, for example, in FIG. 3, FIG. 7A and FIG. 7B.

Various embodiments of the disclosure may provide a non-transitory computer readable medium and/or storage medium having stored thereon, instructions executable by a machine and/or a computer to operate a system (e.g., the computer system 202) for generation of synthetic datasets using machine learning (ML) models for zero-shot classification. The instructions may cause the machine and/or computer to perform operations that include receiving a first input that includes a plurality of labels. The operations further include generating a first prompt associated with a first label of the plurality of labels. The operations further include applying a first ML model to the first prompt. The first ML model is a trained model. The operations further include generating a first set of labelled datapoints based on the application of the first ML model to the first prompt. The operations further include generating at least a first sub-prompt associated with at least one labelled datapoint of the first set of labelled datapoints. The first sub-prompt is different from the first prompt. The operations further include applying the first ML model to the at least first sub-prompt. The operations further include generating a first subset of labelled datapoints based on the application of the first ML model to the at least first sub-prompt. The first subset of labelled datapoints is different from the first set of labelled datapoints. The operations further include generating a training dataset based on the first set of labelled datapoints and the first subset of labelled datapoints. The operations further include outputting the generated training dataset.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first input comprising a plurality of labels;
generating, by the computer, a first prompt associated with a first label of the plurality of labels;
applying, by the computer, a first machine learning (ML) model to the first prompt, wherein the first ML model is a trained model;
generating, by the computer, a first set of labelled datapoints based on the application of the first ML model to the first prompt;
generating, by the computer, at least a first sub-prompt associated with at least one labelled datapoint of the first set of labelled datapoints, wherein the first sub-prompt is different from the first prompt;
applying, by the computer, the first ML model to the at least first sub-prompt;
generating, by the computer, a first subset of labelled datapoints based on the application of the first ML model to the at least first sub-prompt, wherein the first subset of labelled datapoints is different from the first set of labelled datapoints;
generating, by the computer, a training dataset based on the first set of labelled datapoints and the first subset of labelled datapoints; and
outputting, by the computer, the training dataset.

2. The computer-implemented method of claim 1, further comprising:
applying, by the computer, a set of filters on the first set of labelled datapoints;
determining, by the computer, a quality score associated with the first set of labelled datapoints based on the application of the set of filters on the first set of labelled datapoints;
determining, by the computer, that the quality score associated with the first set of labelled datapoints is greater than or equal to a threshold quality score; and
generating, by the computer, the first sub-prompt for the first ML model based on the determination that the quality score associated with the first set of labelled datapoints is greater than or equal to the threshold quality score.

3. The computer-implemented method of claim 1, further comprising:
applying, by the computer, a set of filters on the first set of labelled datapoints;
determining, by the computer, a quality score associated with the first set of labelled datapoints based on the application of the set of filters on the first set of labelled datapoints;
determining, by the computer, that the quality score associated with the first set of labelled datapoints is less than a threshold quality score;
modifying, by the computer, the first prompt based on the determination that the quality score associated with the first set of labelled datapoints is less than the threshold quality score; and
applying, by the computer, the first ML model to the modified first prompt.

4. The computer-implemented method of claim 1, further comprising:
determining, by the computer, a quality score associated with the first subset of labelled datapoints;
comparing, by the computer, the quality score with a threshold quality score; and
outputting, by the computer, the training dataset based on the comparison.

5. The computer-implemented method of claim 4, wherein the quality score corresponds to one of a confidence score associated with the first subset of labelled datapoints or a perplexity score associated with the first subset of labelled datapoints.

6. The computer-implemented method of claim 1, further comprising:
determining, by the computer, that a first count of labelled datapoints in the training dataset is greater than or equal to a count threshold; and
outputting, by the computer, the training dataset based on the determination that the first count of labelled datapoints in the training dataset is greater than or equal to the count threshold.

7. The computer-implemented method of claim 1, further comprising:
determining, by the computer, that a first count of labelled datapoints in the training dataset is less than a count threshold;
generating, by the computer, a second prompt associated with a second label of the plurality of labels based on the determination that the first count of labelled datapoints in the training dataset is less than the count threshold;
applying, by the computer, the first ML model to the second prompt;
generating, by the computer, a second set of labelled datapoints based on the application of the first ML model to the second prompt;
generating, by the computer, a second sub-prompt associated with at least one labelled datapoint of the second set of labelled datapoints, wherein the second sub-prompt is different from the second prompt;
applying, by the computer, the first ML model to the second sub-prompt;
generating, by the computer, a second subset of labelled datapoints based on the application of the first ML model to the second sub-prompt, wherein the second subset of labelled datapoints is different from the second set of labelled datapoints; and
generating, by the computer, the training dataset based on the second set of labelled datapoints and the second subset of labelled datapoints.

8. The computer-implemented method of claim 7, further comprising:
determining, by the computer, that a second count of labelled datapoints in the training dataset is greater than the count threshold, wherein the training dataset comprises the first set of labelled datapoints, the first subset of labelled datapoints, the second set of labelled datapoints, and the second subset of labelled datapoints; and
outputting, by the computer, the training dataset based on the determination that the second count of labelled datapoints in the training dataset is greater than the count threshold.

9. The computer-implemented method of claim 1, further comprising:
applying, by the computer, one or more data processing techniques on the first set of labelled datapoints and the first subset of labelled datapoints, wherein the one or more data processing techniques comprise at least one of a data deduplication technique or a data sanitization technique; and
generating, by the computer, the training dataset based on the application of the one or more data processing techniques on the first set of labelled datapoints and the first subset of labelled datapoints.

10. The computer-implemented method of claim 1, further comprising training, by the computer, a second ML model based on the training dataset, wherein the second ML model is trained to classify a second input into at least one label of the plurality of labels.

11. The computer-implemented method of claim 10, further comprising tuning one or more hyper-parameters associated with the second ML model based on the training dataset.

12. The computer-implemented method of claim 10, further comprising:
receiving, by the computer, the second input from a user device;
applying, by the computer, the second ML model to the second input;
classifying, by the computer, the second input into the at least one label of the plurality of labels based on the application of the second ML model to the second input; and
rendering, by the computer, the at least one label of the plurality of labels on the user device.

13. The computer-implemented method of claim 10, further comprising:
partitioning, by the computer, the first set of labelled datapoints and the first subset of labelled datapoints into the training dataset and a validation dataset;
training, by the computer, the second ML model based on the training dataset,
validating, by the computer, the second ML model based on the validation dataset;
determining, by the computer, a performance score based on the validation, wherein the performance score is associated with one or more performance metrics of the second ML model; and
outputting, by the computer, the second ML model.

14. The computer-implemented method of claim 13, wherein the one or more performance metrics correspond to at least one of an accuracy of the second ML model, a precision of the second ML model, a recall of the second ML model, or a confusion matrix of the second ML model.

15. A computer system, comprising:
a processor set;
one or more computer-readable storage media; and
program instructions stored on the one or more computer-readable storage media, the program instructions executable by the processor set to cause the processor set to:
receive a first input that comprises a plurality of labels;
generate a first prompt associated with a first label of the plurality of labels;
apply a first machine learning (ML) model to the first prompt, wherein the first ML model is a trained model;
generate a first set of labelled datapoints based on the application of the first ML model to the first prompt;
generate at least a first sub-prompt associated with at least one labelled datapoint of the first set of labelled datapoints, wherein the first sub-prompt is different from the first prompt;
apply the first ML model to the at least first sub-prompt;
generate a first subset of labelled datapoints based on the application of the first ML model to the at least first sub-prompt, wherein the first subset of labelled datapoints is different from the first set of labelled datapoints;
generate a training dataset based on the first set of labelled datapoints and the first subset of labelled datapoints;
train a second ML model based on the training dataset, wherein the second ML model is trained to classify a second input into at least one label of the plurality of labels; and
output the second ML model.

16. The computer system of claim 15, wherein the program instructions further cause the processor set to:
determine a quality score associated with the first subset of labelled datapoints, wherein the quality score corresponds to one of a confidence score associated with the first subset of labelled datapoints or a perplexity score associated with the first subset of labelled datapoints;
compare the quality score with a threshold quality score; and
output the training dataset based on the comparison.

17. The computer system of claim 15, wherein the program instructions further cause the processor set to:
determine that a first count of labelled datapoints in the training dataset is greater than or equal to a count threshold; and
output the training dataset based on the determination that the first count of labelled datapoints in the training dataset is greater than or equal to the count threshold.

18. The computer system of claim 15, wherein the program instructions further cause the processor set to:
determine that a first count of labelled datapoints in the training dataset is less than a count threshold;
generate a second prompt associated with a second label of the plurality of labels based on the determination that the first count of labelled datapoints in the training dataset is less than the count threshold;
apply the first ML model to the second prompt;
generate a second set of labelled datapoints based on the application of the first ML model to the second prompt;
generate a second sub-prompt associated with at least one labelled datapoint of the second set of labelled datapoints, wherein the second sub-prompt is different from the second prompt;
apply the first ML model to the second sub-prompt;
generate a second subset of labelled datapoints based on the application of the first ML model to the second sub-prompt, wherein the second subset of labelled datapoints is different from the second set of labelled datapoints; and
generate the training dataset based on the second set of labelled datapoints and the second subset of labelled datapoints.

19. The computer system of claim 18, wherein the program instructions further cause the processor set to:
determine that a second count of labelled datapoints in the training dataset is greater than the count threshold, wherein the training dataset comprises the first set of labelled datapoints, the first subset of labelled datapoints, the second set of labelled datapoints, and the second subset of labelled datapoints; and
output the training dataset based on the determination that the second count of labelled datapoints in the training dataset is greater than the count threshold.

20. A computer-program product for generation of a training dataset, the computer-program product comprising:
one or more computer-readable storage media; and
program instructions stored on the one or more computer-readable storage media to perform operations comprising:
receiving a first input that comprises a plurality of labels;
generating a first prompt associated with a first label of the plurality of labels;
applying a first machine learning (ML) model to the first prompt, wherein the first ML model is a trained model;
generating a first set of labelled datapoints based on the application of the first ML model to the first prompt;
generating at least a first sub-prompt associated with at least one labelled datapoint of the first set of labelled datapoints, wherein the first sub-prompt is different from the first prompt;
applying the first ML model to the at least first sub-prompt;
generating a first subset of labelled datapoints based on the application of the first ML model to the at least first sub-prompt, wherein the first subset of labelled datapoints is different from the first set of labelled datapoints;
generating the training dataset based on the first set of labelled datapoints and the first subset of labelled datapoints; and
outputting the generated training dataset.
